(19) United States
(12) Patent Application Publication
(10) Pub. No.: US 2025/0211382 A1
(43) Pub. Date: Jun. 26, 2025

(54) FRAME STRUCTURE DESIGN FOR AMBIENT IOT SYSTEMS

(71) Applicant: Samsung Electronics Co., Ltd., Suwon-si (KR)

(72) Inventors: Yaser Mohamed Mostafa Kamal Fouad, San Diego, CA (US); Philippe Jean Marc Michel Sartori, Naperville, IL (US); Yuhan Zhou, San Diego, CA (US)

(21) Appl. No.: 18/976,668

(22) Filed: Dec. 11, 2024

Related U.S. Application Data
(60) Provisional application No. 63/612,673, filed on Dec. 20, 2023.

(51) Int. Cl. H04L 5/00; H04L 5/14; H04W 72/20

(52) U.S. Cl. CPC H04L 5/0044; H04L 5/0078; H04L 5/14; H04W 72/20

(57) ABSTRACT

A system and a method are disclosed for ambient Internet of Things (A-IoT) systems. The system and method include transmitting a carrier wave to an ambient Internet of Things (IoT) device, transmitting a control signal and a payload signal to the A-IoT device, and receiving a back scattering signal from the A-IoT device after a time delay. The time delay is between the transmitting of the control signal and the receiving of the back scattering signal.

### CROSS-REFERENCE TO RELATED APPLICATION

This application claims the priority benefit under 35 U.S.C. § 119(e) of U.S. Provisional Application No. 63/612,673, filed on Dec. 20, 2023, the disclosure of which is incorporated by reference in its entirety as if fully set forth herein.

### TECHNICAL FIELD

The disclosure generally relates to Internet of Things (IoT) devices. More particularly, the subject matter disclosed herein relates to improvements in power consumption of ambient IoT devices.

### BACKGROUND

Ambient Internet of Things (AIoT) systems are expected to offer applications that involve low cost and low complexity devices. Examples of such applications include asset tracking and equipment health monitoring. The simplicity of such devices is mainly due to being battery free in most cases and thus are applicable in extreme environmental conditions (e.g. high pressure, extremely high/low temperature, humid environment, etc.). Although the majority of these devices are battery free, they are still capable of communicating with the base station and achieving ranges up to 500 meters for outdoor applications. Low power consumption when operating ambient IoT devices is important in most applications.

### SUMMARY

Since ambient IoT devices do not require battery replacement and are fairly inexpensive to produce, they are applicable in scenarios wherein a large number of devices may be required. To realize the design of ambient IoT, in NR Rel-18, a study item was conducted to identify the practicality of ambient IoT devices [3GPP TR 38.848]. Standardization work is expected to continue in NR Rel-19.

Ambient IoT systems are expected to offer applications that involve massive numbers of low cost/complexity devices. Such devices are expected to have multiple orders of magnitude less complexity than NB-IoT to compete with RFID systems. Examples of application for ambient IoT devices include automated warehousing (i.e., indoor inventory), smart agriculture (i.e., indoor sensors), or location services (i.e., indoor positioning).

Different topologies have been proposed for AIoT systems in which devices can either rely on back scattering or device generated signals to communicate with the reader (eNB or intermediate node). In NR 3GPP Rel-19, a study item for AIoT systems has an objective to study a harmonized air interface design with minimized differences for A-IoT with low peak power, such as ˜1 μW peak power consumption.

To solve this problem, sidelink communications may potentially be used for AIoT/Reader communications. However, issues with using sidelink communications is that the standard frame structure is too complex, OFDM-based solutions include many reference signals, the current frame structure does not support backscattering, and unnecessary features such as self-containment and ACK/NACK feedback are supported.

Issues with the above sidelink approach is that the power consumption may be high due to various unnecessary features, complexity, and use of many reference signals.

To overcome these issues, systems and methods are described herein for a new frame structure to support AIoT applications. Given the unique nature of AIoT devices (i.e., their limited power and capabilities and mass numbers), a frame structure that it tailored towards facilitating the communications with these ambient IoT devices may be needed. In particular, battery-less IoT devices may need the presence of an energizing signal, since IoT devices may be reliant on back scattering for communications. Furthermore, relaxed latency requirements and limited transmission/processing capabilities of such devices may also have an impact on the design of the frame structure. Hence, multiple possible designs of a frame structure that can efficiently handle the communications from large numbers of ambient IoT devices with limited capabilities may be proposed. A frame structure design with a dedicated energizing signal is proposed. A frame structure design with a common energizing signal is also proposed. A modulated energizing signal is also proposed.

The above approaches improve on previous methods. For example, the proposed a frame structure for AIoT devices supports TDD and/or FDD configurations of AIoT systems. FDD configurations may result in Frequency Division Multiple Access (FDMA) of ambient IoT device transmissions of the ambient IoT devices. Multiple dedicated energizing signals may be transmitted for AIoTs to perform back scattering with time gaps to allow for energy harvesting. The dedicated energizing signal supports the splitting of control signaling to reduce processing requirements at AIoT devices. The frame structure design with a common energizing signal involves transmission of a single energizing signal on a common carrier to be used by the AIoT devices for energy harvesting and back scattering. The AIoT device transmissions can still be frequency multiplexed by applying small frequency shifts. The modulating energizing signal solution that is proposed improves system efficiency by using a modulated energizing signal for DL control/data signaling.

In some embodiments, a method includes transmitting a carrier wave to an ambient Internet of Things (A-IoT) device, transmitting a control signal and/or a payload signal to the A-IoT device, and receiving a back scattering signal from the A-IoT device after a time delay. The time delay is between the transmitting of the control signal and/or the payload signal and the receiving of the back scattering signal.

In some embodiments, the time delay may include time for energy harvesting of the carrier wave by the A-IoT device. The time delay may be an activation time of the A-IoT device or processing time of the control signal and/or the payload signal by the A-IoT device. The control signal may include a first control segment and a second control segment, the first control segment may be transmitted after an activation delay for the A-IoT device to be activated, and the second control segment may be transmitted after the first control segment. Low complexity devices are configured to decode the first control segment and high complexity devices are configured to decode the first control segment and the second control segment.

In some embodiments, the carrier wave may include a common carrier wave used by a plurality of A-IoT devices that includes the A-IoT device. When performing back scattering, each of the plurality of A-IoT devices may apply a respective small frequency shift from a carrier frequency of the common carrier wave resulting in Frequency Division Multiple Access (FDMA) of A-IoT device transmissions of the plurality of A-IoT devices. The carrier wave may include a first carrier wave transmitted by a first reader device, and a second carrier wave transmitted by a second reader device. The first carrier wave and the second carrier wave are transmitted in a Time Division Multiple Access (TDMA) manner such that the first carrier wave is transmitted by the first reader device in a first time slot and the second carrier wave is transmitted by the second reader device in a second time slot. The first carrier wave and the second carrier wave are transmitted in a Frequency Division Multiple Access (FDMA) manner such that the first carrier wave is transmitted by the first reader device on a first frequency and the second carrier wave is transmitted by the second reader device on a second frequency.

In some embodiments, the carrier wave may include a common carrier wave used by a plurality of A-IoT devices comprising the A-IoT device. The method may further include transmitting the control signal in a first time slot on a first frequency that is a small frequency offset from a carrier frequency, and transmitting a data signal on the first frequency in a second time slot that does not overlap the first time slot. The first time slot and the second time slot are separated by the time delay that is used by the A-IoT device for energy harvesting and/or processing.

In some embodiments, the back scattering signal may include back scattered control information and back scattered data. The method may further include receiving the back scattered control information from the A-IoT device in a third time slot that does not overlap with the first time slot and the second time slot, and receiving the back scattered data from the A-IoT device in a fourth time slot that does not overlap with the first time slot, the second time slot, and the third time slot. The carrier wave includes a respective dedicated carrier wave for each of a plurality of A-IoT devices. A first A-IoT device of the plurality of A-IoT devices uses a first carrier wave at a first carrier frequency and a second A-IoT device of the plurality of A-IoT devices uses a second carrier wave at a second carrier frequency that is different from the first carrier frequency.

In some embodiments, the method may include transmitting the control signal to the first A-IoT device on the first carrier frequency during a first time period, and receiving, from the first A-IoT device, the back scattering signal comprising device to reader data on the first carrier frequency in a second time period that is separated from the first time period by a time gap. The method may further include transmitting the control signal to the first A-IoT device on the first carrier frequency during a first time period, and receiving, from the first A-IoT device, the back scattering signal comprising device to reader data on a third carrier frequency that is slightly offset from the first carrier frequency in a second time period that is separated from the first time period by a time gap.

In some embodiments, the carrier wave include a modulated carrier wave that is used to carry control information and/or data information. Transmitting the control signal to the A-IoT device may include transmitting the carrier wave on a first frequency that is unmodulated in a first time slot, and transmitting the control signal and a data signal on the first frequency in a second time slot, wherein the carrier wave is modulated to carry the control signal the data signal. The first time slot is time separated from the second time slot.

In some embodiments, the method may include receiving the back scattering signal from the A-IoT device on a second frequency that is shifted by a small frequency shift from the first frequency. The method may include using frequency division duplexing (FDD) in which the control signal and/or the payload signal to the A-IoT device are transmitted in a carrier wave that is frequency separated from the back scattering signal from the A-IoT device, and the A-IoT device applies a large frequency shift when transmitting the back scattering signal, and using time division duplexing (TDD) in which the control signal and/or the payload signal to the A-IoT device are transmitted in a first time slot that is separated from a second time slot in which the back scattering signal from the A-IoT device is received.

In some embodiments, a system may include a node comprising a transceiver configured to transmit and receive signals to an ambient Internet of Things (A-IoT) device. The node is configured to perform operations including transmitting a carrier wave to the A-IoT device, transmitting a control signal and a payload signal to the A-IoT device, and receiving a back scattering signal from the A-IoT device after a time delay. The time delay is between the transmitting of the control signal and/or the payload signal and the receiving of the back scattering signal.

In some embodiments, the time delay may include time for energy harvesting of the carrier wave by the A-IoT device, an activation time of the A-IoT device, and/or a processing time of the control signal by the A-IoT device. The control signal may include a first control segment and a second control segment. The first control segment may be transmitted after an activation delay for the A-IoT device to be activated, the second control segment may be transmitted after the first control segment, and low complexity devices may be configured to decode the first control segment and high complexity devices are configured to decode the first control segment and the second control segment.

In some embodiments, an electronic device includes at least one processor, a transceiver, and at least one memory device comprising computer program code embodied on a non-transitory computer readable medium. The computer program code is configured to cause the at least one processor to perform operations including transmitting, by the transceiver, a carrier wave to an ambient Internet of Things (A-IoT) device, transmitting, by the transceiver, a control signal and/or a payload signal to the A-IoT device, and receiving, by the transceiver, a back scattering signal from the A-IoT device after a time delay. The time delay is between the transmitting of the control signal and/or the payload signal and the receiving of the back scattering signal.

### BRIEF DESCRIPTION OF THE DRAWING

In the following section, the aspects of the subject matter disclosed herein will be described with reference to example embodiments illustrated in the figures, in which:

FIG. 1 is an example system including an ambient IoT device, a base station, and an assisting node, according to various embodiments.

FIG. 2 illustrates a slot format with feedback, according to various embodiments.

FIG. 3 illustrates a slot format without feedback, according to various embodiments.

FIG. 4 illustrates an example ambient IoT topology with direct base station to ambient IoT device communication, according to various embodiments.

FIG. 5 illustrates an example of ambient IoT topology with an intermediate node between the base station and ambient IoT device, according to various embodiments.

FIG. 6 illustrates an example of ambient IoT topology with an assisting node for downlink assistance, according to various embodiments.

FIG. 7 illustrates an example of ambient IoT topology with an assisting node for uplink assistance, according to various embodiments.

FIG. 8 illustrates an example of ambient IoT topology with a UE in communication with the IoT device, according to various embodiments.

FIG. 9 is an architecture of a Type AIoT device, according to various embodiments.

FIG. 10 is an architecture of a Type C IoT device, according to various embodiments.

FIG. 11 illustrates an example of resource pools for ambient IoT communication for a TDD case, according to various embodiments.

FIG. 12 illustrates an example of resource pools for ambient IoT communication for a FDD case, according to various embodiments.

FIG. 13 illustrates the organization of a resource pool, according to various embodiments.

FIG. 14 illustrates a subchannel carrying an energizing signal along with control and data signals, according to various embodiments.

FIG. 15 illustrates FDD support between the control/data signals from the source and the back scattered signal from the ambient IoT device, according to various embodiments.

FIG. 16 illustrates the subchannel structure for a subchannel in the resource pool for type-A UEs in the TDD case, according to various embodiments.

FIG. 17 illustrates FDD support between the control/data signals from the source and the back scattered signal from the ambient IoT device in separate bandwidth parts (BWPs), according to various embodiments.

FIG. 18 illustrates the subchannel structure for a subchannel in the resource pool for type-A UEs in the TDD case, according to various embodiments.

FIG. 19 illustrates a frame structure design to support ambient IoT devices, according to various embodiments.

FIG. 20 illustrates an ambient IoT frame structure with all control signals contained within one slot, according to various embodiments.

FIG. 21 illustrates an ambient IoT frame structure with all control and data signals contained within one slot, according to various embodiments.

FIG. 22 illustrates an example frame structure design that carries the feedback information from the ambient IoT devices to the source, according to various embodiments.

FIG. 23 illustrates a frame structure with a time gap in the energizing signal to save power, according to various embodiments.

FIG. 24 illustrates an additional control signal that is added after the time gap duration to ensure the triggering of only the targeted devices, according to various embodiments.

FIG. 25 illustrates that the energizing signal is extended to ensure enough time for the reception of the back scattered signal, according to various embodiments.

FIG. 26 illustrates frequency multiplexing of the back scattered signal from multiple ambient IoT devices in one subchannel, according to various embodiments.

FIG. 27 illustrates frequency multiplexing of the back scattered signal from multiple ambient IoT devices in multiple subchannels, according to various embodiments.

FIG. 28 illustrates an FDD resource pool structure with contiguous energizing signal, according to various embodiments.

FIG. 29 illustrates an FDD resource pool structure with the energizing signal sent two slots before the first slot of a resource pool for device activation and energy harvesting, according to various embodiments.

FIG. 30 illustrates a resource pool structure (U-pool) for type-B UEs with slots dedicated for energy harvesting, according to various embodiments.

FIG. 31 illustrates the use of a common energizing signal to energize ambient IoT devices, according to various embodiments.

FIG. 32 illustrates the use of a modulated energizing signal to trigger ambient IoT devices, according to various embodiments.

FIG. 33 illustrates a TDD frame structure for ambient IoT Type-A devices, according to various embodiments.

FIG. 34 illustrates a TDD frame structure for ambient IoT Type-B devices, according to various embodiments.

FIGS. 35 to 40 are flowcharts of operations for methods, according to some embodiments.

FIG. 41 is a block diagram of an electronic device in a network environment, according to some embodiments.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Energizing signal” or “carrier wave” as used herein refers to a signal that includes energy or power that may be used by and IoT device to harvest energy.

“Back scattering signal” as used herein refers to a signal sent from an AIoT device to a UE, intermediate node, assisting node, base station, or other device.

“IoT device” as used herein refers to an Internet of Things (Iot) device, including ambient IoT devices.

“Small frequency shift” as used herein refers to a relatively small time delay from a carrier frequency. These small frequency shifts rely on time separation, i.e., small delays in time to achieve small frequency shifts, such as, for example, on the order of 1 kHz to 100 kHz. In contrast, large frequency shifts may be on the order of tens of MHz. Small frequency shifts entail a relatively small time delay, but does not entail the signal being transmitted on a different carrier.

AIoT systems are expected to play a key role in enabling a wide range of applications. However, for such systems to operate efficiently the AIoT devices must be energized and the AIoT devices must be able to be multiplexed with cellular devices. Therefore, there is the need for a new frame structure for IoT devices in a cellular system. Multiple frame structure designs that consider the presence of an energizing signal and allow enough time for processing and energy harvesting are needed. The frame structure designs also include allocations for uplink (device to reader) and downlink (reader to device) control and data signaling. Furthermore, the proposed frame structure designs support both TDD and FDD transmissions and multi-carrier operation for more capable AIoT devices. Since a large number of AIoT devices are expected to be present in a given location, the proposed frame structures also allows the time and frequency multiplexing of multiple AIoT transmissions. An approach that relies on a common energizing signal for AIoT device activation to reduce the amount of power transmitted is supported. Finally, the usage of a modulated energizing signal for control/data signaling between the source and the AIoT devices is also supported.

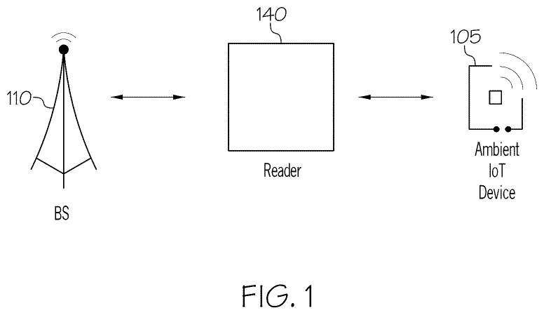

FIG. 1 is an example system including an IoT device, a base station, and a reader, according to various embodiments. Referring to FIG. 1, a reader 140, which is node such as a UE, assisting node, or intermediary device, may communicate with an AIoT device 105. The AIoT device 105 may receive an energizing signal from the reader 140 and perform energy harvesting for powering the AIoT device 105. AIoT device 105 may have an energy storage component that stores the harvested energy. A base station 110 may be in communication with reader 140 and provide network level functionality to the AIoT device 105 via the reader 140. A gNB (gNodeB) may be the 5G/6G equivalent of a base station in a cellular network. The terms “base station” and “gNB” are used interchangeably herein.

A frame structure may be used for communication in a network, such as for communication from base station 110 to reader 140 and/or communication to AIoT device 105. However, legacy frame structures may not be suitable for efficient power usage by AIoT device 105. A frame structure may include a sidelink physical channel that may correspond to a set of resource elements carrying information originating from higher layers. Sidelink physical channels may include Physical Sidelink Shared Channel (PSSCH) which carries second stage Sidelink Channel Information (SCI) and a sidelink data payload, Physical Sidelink Broadcast Channel (PSBCH) which is equivalent to PBCH in a Uu link. Physical Sidelink Control Channel (PSCCH) which carries first stage SCI, and Physical Sidelink Feedback Channel (PSFCH) which carriers 1-bit HARQ-ACK feedback. A sidelink physical signal corresponds to a set of resource elements used by the physical layer but does not carry information originating from higher layers. Defined sidelink physical signals include Demodulation reference signals (DM-RS) for PSCCH, PSSCH and PSBCH, Channel-state information reference signal (CSI-RS) for CSI measurement on sidelink, Phase-tracking reference signals (PT-RS) for FR2 phase noise compensation, Sidelink primary synchronization signal (S-PSS) for synchronization on the sidelink, and Sidelink secondary synchronization signal (S-SSS) for synchronization on the sidelink.

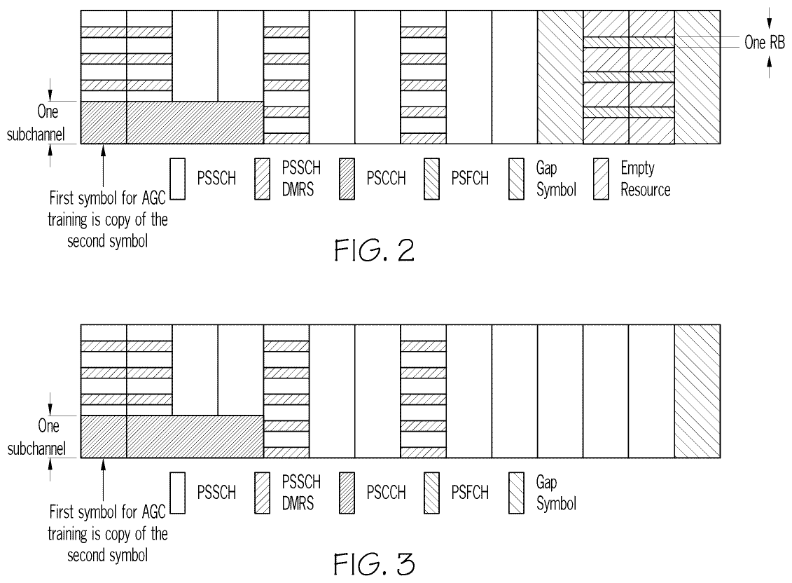

In New Radio (NR) sidelinks, a self-contained approach is used, whereby each slot includes control, data, and, in some cases, feedback. A regular NR sidelink slot includes 14 OFDM symbols. However, the sidelink may also be pre-configured to occupy less than 14 symbols in a slot. Sidelink control information (SCI) in NR V2X is transmitted in two stages. The first stage SCI (e.g., SCI format 1-A) carried on PSCCH includes information to enable sensing operations, as well as the resource allocation field for the scheduling of PSSCH and second stage SCI. The second stage SCI (e.g., SCI format 2-A and SCI format 2-B) is transmitted in PSSCH resources and associated with the PSSCH DMRS, which includes information for decoding PSSCH. The PSCCH and PSSCH are multiplexed in time and frequency within the same slot. Depending on whether feedback is configured for a given slot, there may be different slot formats, which are shown in FIG. 2 for the case with feedback resources configured and FIG. 3 for the case without feedback resources configured.

FIG. 2 illustrates a slot format with feedback, according to various embodiments. FIG. 3 illustrates a slot format without feedback, according to various embodiments. Referring to FIG. 2 and FIG. 3, both of these different slot formats, the first symbol is repeated for Automatic Gain Control (AGC) settling, and the last symbol of the slot is left as a gap for the time of Tx/Rx switching. The first stage SCI is carried in PSCCH with two or three symbols. The number of PSCCH symbols is explicitly pre-configured per Tx/Rx resource pool by the higher layer parameter sl-TimeResourcePSCCH. The lowest resource block (RB) of a PSCCH is the same as the lowest RB of the corresponding PSSCH. In the frequency domain, the number of RBs in PSCCH is pre-configured, which is not greater than the size of one sub-channel. Note that in this case, if a UE is using multiple consecutive subchannels for SL transmission within a slot, the PSCCH will only exist in the first subchannel. The SL-SCH transport channel, which carries the transport blocks (TBs) of data for transmission over the SL, and the second stage SCI is carried over the PSSCH. The resources in which the PSSCH is transmitted may be scheduled or configured by a gNB or determined through a sensing procedure conducted autonomously.

The SL-SCH transport channel, which carries the transport blocks (TBs) of data for transmission over the SL, and the second stage SCI is carried over the PSSCH. The resources in which the PSSCH is transmitted may be scheduled or configured by a gNB or determined through a sensing procedure conducted autonomously. The feedback as shown in FIG. 2 is carried over the PSFCH. This channel is used to transmit the feedback information from the receiver to the transmit UEs. It may be used for Unicast and groupcast options 1 and 2. In case of unicast and groupcast option 2, the PSFCH is used to transmit ACK/NACK whereas for the case of groupcast option 1, the PSFCH carries only the NACK. For sidelink feedback, a sequence-based PSFCH format (PSFCH format 0) with one symbol (not including AGC training period) is supported. In PSFCH format 0, the ACK/NACK bit is transmitted through two Zadoff-Chu (ZC) sequences of length 12 (with same root but different cyclic shift), whereby the presence of one sequence indicates an ACK and the presence of the other indicates a NACK (i.e., these sequences are used in a mutually exclusive manner).

The present inventive concepts arise from the recognition of a need for efficient energy usage for operation of IoT devices. The present inventive concepts introduce TDD-based and FDD-based resource pool configurations for AIoT systems. Different resource pool configuration parameters are introduced for AIoT systems, with possible channels defined within a resource pool. A dedicated frame structure design is presented in which each set of frequency resources are assigned with an energizing signal to be used by the AIoT device when performing back scattering. The proposed energizing signal may be frequency multiplexed with the control/data signals to enable the device activation. The concept of energizing gaps are included to allow AIoT device type A and type B to perform energy harvesting. The segmentation of the downlink control signal may be provided to reduce the processing burden on the IoT devices (e.g., low end devices may process a subset of the segments). Time and frequency multiplexing may occur between the back scattered signals carrying control and data from the AIoT devices. Partial monitoring of the control signaling from the source may be provided to preserve or reduce the energy of the AIoT devices. In some embodiments, a more efficient common frame structure design is described herein in which all frequency resources are assigned with a single energizing signal to be used by the AIoT device when performing back scattering. In this case, the carrier may be configured or standardized. In some embodiments, a modulated energizing signal may be provided to carry control/data signaling. Dynamically determined energizing duration may be used based on channel measurements and previous feedback.

There are numerous advantages provided by the present inventive concepts. For example, the distribution of resources for different AIoT device types with different configuration parameters may be facilitated by the frame design. The exchange of control/data may be enabled between AIoT devices and the reader through different channels (e.g., data, control, synchronization, etc.). The processing burden on the AIoT devices may be reduced since there is not a need for a large frequency shift when performing the backscattering on the dedicated energizing signal, according to various embodiments. The resource utilization may be improved with reduced latency by allowing the frequency multiplexing between the control/data signals and the energizing signal. Various embodiments described herein allow enough time for A-IoT devices to charge their on-board energy sources before performing their back scattered transmissions. The processing requirement may be reduced for low end AIoT devices since a subset of the control segments sent by the source may be processed. The resource utilization may be improved by allowing the AIoT to frequency multiplex the control and data signals. In some embodiments, more time for the AIoT devices to perform energy harvesting may be provided, since the AIoT devices may partially monitor the control signaling from the source. The overhead associated with the energizing signals may be reduced by sending one energizing signal on a common carrier. However, use of the common carrier may require AIoT devices to perform up/down conversion when performing their back scattering transmissions. According to some embodiments, the resource utilization may be improved by allowing the energizing signal to carry control/data signaling from the source. An adequate duration of energizing signal based on channel measurements performed by the source may be provided. This improves performance since a good channel quality will allow an AIoT device to perform faster energy harvesting when compared to a device in bad channel conditions.

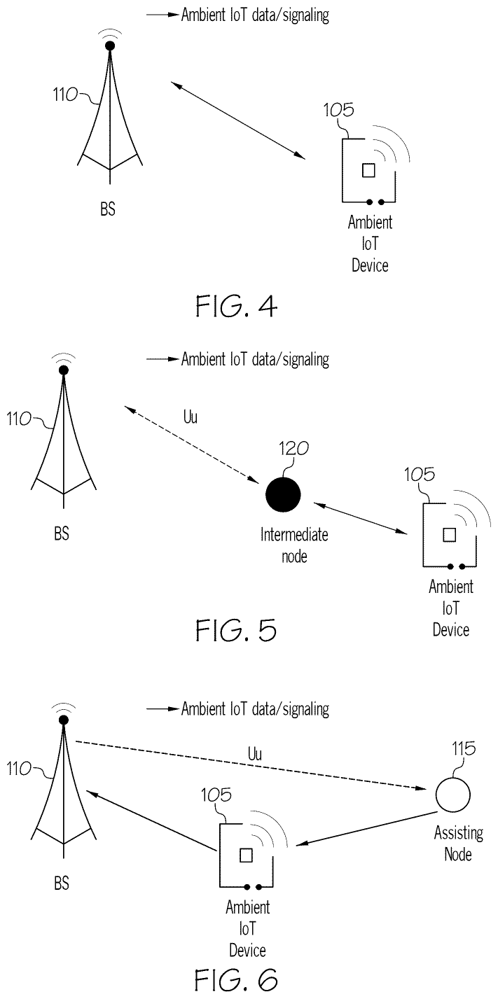

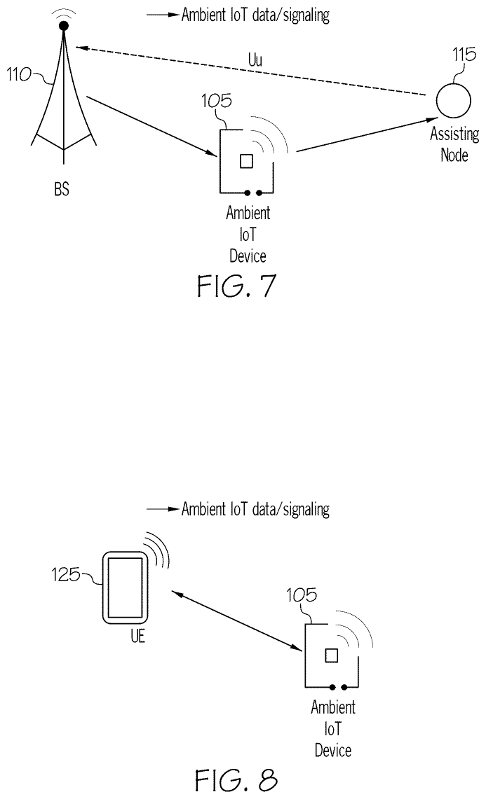

FIG. 4, FIG. 5, FIG. 6, FIG. 7, and FIG. 8 illustrate example topologies for networks that include AIoT devices. In AIoT systems, the expectation is that a significantly large number of devices will be deployed in the field. Hence, these devices are expected to be much cheaper than narrowband IoT devices and thus may be orders of magnitude simpler than their NB-IoT counterparts. In one study conducted by 3GPP, ambient IoT devices were categorized by their energy storage capacity and their capability of generating RF signals for their transmissions. The three categories of devices include Device A which has no energy storage, no independent signal generation/amplification, i.e. backscattering transmission, Device B which has energy storage, no independent signal generation, i.e. backscattering transmission, and uses stored energy which can include amplification for reflected signals, and Device C which has energy storage, has independent signal generation, i.e., active RF components for transmission. For all of these device categories (i.e., A, B and C), the expectation is that they are able to demodulate control and data from the relevant entity in RAN (e.g., UE or gNB) according to the underlying topology. AIoT devices are expected to operate in different environments (e.g., outdoor and indoor) and to support a wide range of communication distances (e.g., large distances for outdoor and small distances for indoor applications).

FIG. 4 illustrates an example IoT topology with direct base station to IoT device communication, according to various embodiments. Referring to FIG. 4, in this topology, the AIoT device 105 directly communicates with the base station 110. This communication is bidirectional with no assistance node in between. In addition, AIoT device 105 may receive from base station 110 and respond to a different base station. Referring again to the topology illustrated in FIG. 4, two types of communication that are supported include: 1) from the gNB 110 to the AIoT device 105, and 2) from the AIoT device 105 to gNB 110.

FIG. 5 illustrates an example of IoT topology with an intermediate node between the base station and IoT device, according to various embodiments. Referring to FIG. 5, in this topology, an intermediate node 120 (e.g., relay, IAB node, UE, repeater) facilitates the communication between an AIoT device 105 and the base station 110. The communication between ambient IoT device and the intermediate node 120 is bidirectional. Referring again to the topology illustrated in FIG. 5, four types of communication that are supported include: 1) from the gNB 110 to the AIoT device 105, and 2) from the AIoT device 105 to gNB 110. Referring again to the topology illustrated in FIG. 5, four types of communication that are supported include: 1) from the gNB 110 to the intermediate node (IN) 120 device, 2) from the IN 120 to AIoT device 105, 3) from the AIoT device 105 to IN 120, 4) from the IN 120 to gNB 110.

FIG. 6 illustrates an example of IoT topology with an assisting node for downlink assistance, according to various embodiments. FIG. 7 illustrates an example of IoT topology with an assisting node for uplink assistance, according to various embodiments. Referring to FIG. 6 and FIG. 7, there exists an assisting node 115 that facilitates the communication between AIoT device 105 and the base station 110 similar to the case of FIG. 5. However, a difference from FIG. 5 is that the communication with the assisting node is not bidirectional. For example, in case of uplink assistance in FIG. 7, the AIoT device 105 receives the downlink communication directly from the base station 110 while sending only the uplink communication through the assisting node 115. Referring again to the topology illustrated in FIG. 6 and FIG. 7, three types of communication that are supported include: 1) from the gNB 110 to the AIoT device 105, 2) from the AIoT device 105 to assisting node 115, 3) from the assisting node 115 to gNB 110.

FIG. 8 illustrates an example of IoT topology with a UE in communication with the IoT device, according to various embodiments. Referring to FIG. 8, in this topology, there is no base station involvement and the communication is bidirectional between an AIoT device 105 and a nearby UE 125. Referring again to the topology illustrated in FIG. 8, two types of communication that are supported include: 1) from the UE 125 to the AIoT device 105, 2) from the AIoT device 105 to the UE 125.

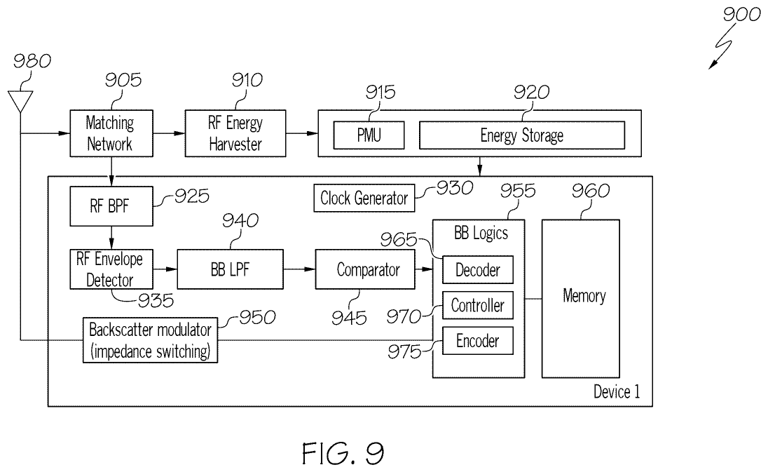

FIG. 9 is an architecture of a Type AIoT device, according to various embodiments. Referring to FIG. 9, Type AIoT device 900 does not include a power source and thus relies on back scattering, with switching between reflecting and absorbing energy. Type AIoT device 900 includes an antenna 980, a matching network 905, an RF energy harvester 910, power management unit 915, energy storage 920, RF BPF 925, clock generator 930, an RF envelop detector 935, BB LPF 940, comparator 945, BB logic 955, memory 960, and a back scatter modulator 950. The BB logic 955 includes decoder 965, controller 970, and encoder 975.

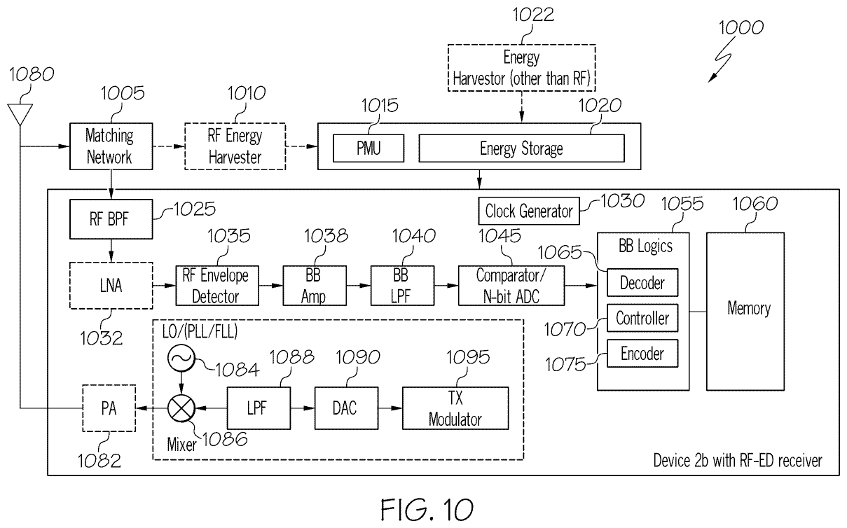

FIG. 10 is an architecture of a Type C IoT device, according to various embodiments. Referring to FIG. 10, Type C IoT device 1000 may include a power source that may produce a small amount of energy, on the order of several hundred u Watts. Type C IoT device 1000 may include an antenna 1080, a matching network 1005, an RF energy harvester 1010, power management unit 1015, energy storage 1020, a non-RF energy harvester 1022, RF BPF 1025, clock generator 1030, an LNA 1032, an RF envelop detector 1035, a BB amp 1038, BB LPF 1040, comparator 1045, BB logic 1055, memory 1060, a power amplifier 1082, power source 1084, mixer 1086, LPF 1088, digital to analog converter 1090, and a transmission modulator 1095. The BB logic 1055 includes decoder 1065, controller 1070, and encoder 1075.

Some of the communications described with respect to FIGS. 4 to 8 may be handled with modifications to existing communication frames. For instance, the communication from the gNB 110 to the IN 120 may be handled by having a new type of Downlink Control Information (DCI), but the existing frame structure may be used for cellular communications. The communications that need to be addressed according to various embodiments described herein are from the gNB 110 to the AIoT device 105, from the AIoT device 105 to gNB 110 device, from the IN 120 to AIoT device 105, from the AIoT device 105 to IN 120, from the UE 125 to the AIoT device 105, and from the AIoT device 105 to the UE 125. As discussed herein, a frame may be an abstract entity, and may be include a subframe, a slot, etc. From a RAN1 perspective, there might not be a need to differentiate whether the source/destination is the gNB, IN, or UE. It may be advantageous to limit the number of frame types to keep the AIoT device 105 as simple as possible. If needed, the same frame format can be used with a field indicating the source/destination.

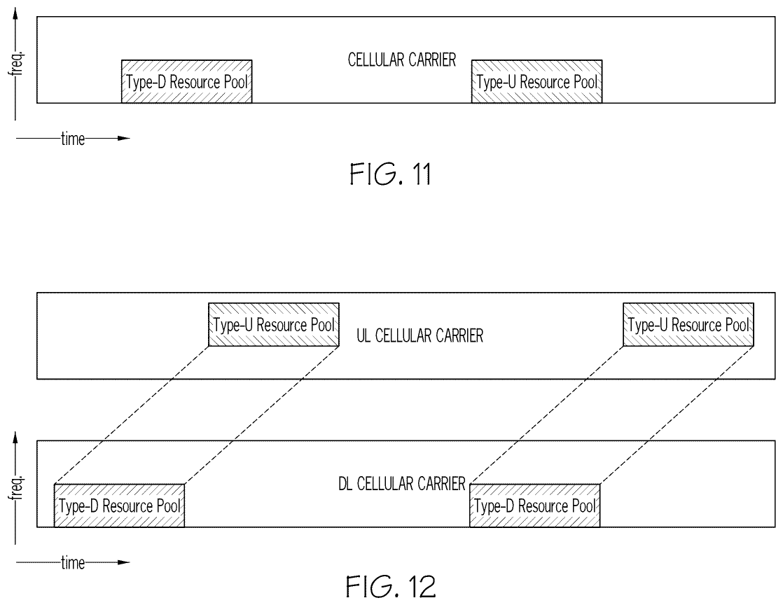

Two types of frames are defined herein: type D from a source (e.g., gNB 110/IN/UE) to the AIoT device 105, and type U from the AIoT device 105 to the destination (g/NB/IN/UE). Similarly, two types of resources may be defined: type D: from a source (e.g., gNB/IN/UE) to the AIoT device 105, and type U: from the AIoT device 105 to the destination (e.g., gNB/IN/UE). In addition, the resources for AIoT device 105 may need to be separated and multiplexed from the resources with cellular communication. Towards this purpose, resource pools for type-D UEs and type-U UEs. These resource pools are resources reserved for AIoT device 105 communication. The illustration of resource pools for AIoT device 105 is shown in FIG. 11 for a TDD carrier and in FIG. 12 for an FDD carrier.

FIG. 11 illustrates an example of resource pools for IoT communication for a TDD case, according to various embodiments. FIG. 12 illustrates an example of resource pools for IoT communication for a FDD case, according to various embodiments. Referring to FIG. 11 and FIG. 12, For an FDD carrier, the resource pools may be lined up as shown in FIG. 12, with the type-U resource pool being at an offset of the type-D resource pool. For simplicity, the two resource pools are shown with the same number of resources, both in time and frequency, but this is a non-limiting example. The offset may be 0, i.e., the type-D and type-U resource pools are lined up in time domain.

In some scenarios, the type-U resource pool may be located in a different carrier from that used for the type-D resource pool. Using a carrier with a lower frequency may be beneficial for AIoT originating communication due to the limited power available since the incurred pathloss decreases with carrier frequency. On the other hand, allocating the type-D resource pool in a different carrier may increase the bandwidth available for communication, thus allowing a gNB to communicate with a larger number of AIoTs simultaneously.

Since Type-A and Type-B UEs may require an energizing signal to operate and transmit data, it may be likely that the energizing signal will be sent in both carriers from the source especially for Type-A UEs. In other words, the energizing signal may be sent in the type-U and the type-D resource pools simultaneously. This will allow the AIoT devices to harvest the energy in the type-D resource pool and accordingly be able to activate its circuity and detect the incoming communication from the source (e.g., gNB or IN). Similarly, an energizing signal may need to be transmitted in the type-U resource pool to enable the AIoT devices to activate and perform the necessary back scattering to pass their signals to the source (i.e., the gNB or the IN). Some more complex or capable AIoT devices (e.g., Type-B devices) might be able to operate with only one energizing signal. This energizing signal may be either sent in the type-U resource pool or the type-D resource pool. In particular, if the energizing signal is sent in the type-U resource pool, the AIoT device may first activate, perform energy harvesting to charge its onboard energy source, then switch to detect the transmission coming from the source in the type-D resource pool. Subsequently, the AIoT may then switch to the type-U resource pool, harvest the energy and perform the backscattering to send its payload to the source. Similarly, the energizing signal may be sent only in the type-D resource pool. In this case, the AIoT device may harvest the energizing signal first, charge its onboard energy source and then perform the detection of the transmissions coming from the source. Subsequently, the AIoT device may also harvest the energizing signal, charge its onboard energy source, and then perform a transmission in the type-U resource pool. Finally, in some cases, the energizing signal may be sent in a common carrier that is outside of the type-U and type-D resource pool, as will be discussed in the following sections.

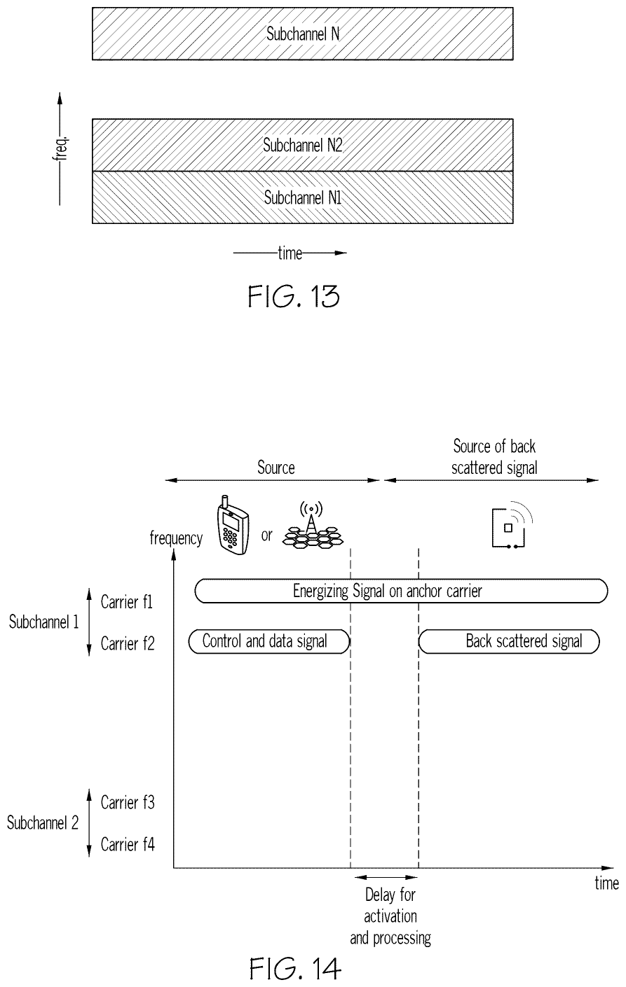

The resource pools for AIoT devices could be defined in a similar way as for sidelink resource pools and include the time resources occupied (slots or subframes), the resource blocks occupied, if the resource pool is for communication with a UE/IN/gNB, if the resource pool is type-D or type-U (not applicable for type-A devices), if the resource pool is for type-A/type-B/type-C devices. The signaling of the resource pool could be by RRC signaling or by pre-configuration in case of the default resource pool. The signaling could either be UE-specific or in a new system information block (SIB) defining AIoT resources. A resource pool may be divided into subchannels. A subchannel is defined as a set of RBs (contiguous or not, although contiguous is preferred) within the resource pool, as illustrated in FIG. 13.

FIG. 13 illustrates the organization of a resource pool, according to various embodiments. Referring to FIG. 13, the subchannel configuration may be indicated in the resource pool configuration and indicates the subchannel width (in terms of RBs or subcarriers), number of subchannels, etc. The subchannel may carry the energizing signal (at least for type A/B devices), control information, data payload, various signals (e.g., for synchronization, demodulation, etc.). The energizing signal may be either included in the subchannel, or be at a different location. In the following sections, we discuss these two cases.

The resource pools for AIoT devices will now be discussed. In some embodiments, for an FDD carrier, the resource pools could be lined up with the type-U resource pool being at an offset of the type-D resource pool. In some embodiments, the energizing signal might be transmitted in type-U and type-D resource pools to ensure that all AIoT devices can perform energy harvesting. In some embodiments, A resource pool configuration may indicate the time resources occupied (slots or subframes), the resource blocks occupied, if the resource pool is for communication with a UE/IN/gNB, if the resource pool is type-D or type-U (not applicable for type-A devices), and/or if the resource pool is for type-A/type-B/type-C devices. In some embodiments, A resource pool may include one or more subchannels (i.e., a set of physical resource blocks (PRBs)) each of which can carry an energizing signal (at least for type A/B devices), control information, data payload, and/or various signals (e.g., for synchronization, demodulation, etc.).

A frame structure design with a dedicated energizing signal for type-A UEs will now be discussed in detail. When trying to reach an AIoT device (especially for Type-A devices) the source (e.g., gNB or a UE) may need to provide an energizing signal (referred to as a wake-up signal). This energizing signal serves two main purposes: 1) activates the ambient IoT device to perform the internal processing of the received user data and control messages as well as generate the control and data to be transmitted, and 2) provides the signal that will be back scattered by the device to communicate with the source or destination.

However, a distinguishing factor between types A and B is that Type-A devices do not have any energy storage and thus the energizing signal will need to be maintained, whereas for Type-B device, there exists an on-board energy storage component and thus the energizing signal must be maintained for a longer duration but can be dropped at some instances. A Type-B device may require a longer energizing signal in order to charge its energy source. In order to satisfy the requirements of these devices, several architectures will be discussed. In the case where only Type-A devices exist in the system with frequency division duplexing (FDD) and frequency multiplexing support, a dedicated approach in which the energizing signal is targeted towards either one AIoT device or a subset of AIoT devices (i.e., the energizing signal is sent within the assigned subchannel) will be discussed.

For the dedicated energizing signal approach, each device or a subset of devices may be assigned a dedicated energizing signal that will then be used for backscattering and energizing the device. In particular, the underlying resource pool may be divided into multiple subchannels to allow for frequency multiplexing of multiple AIoT devices. A subchannel may be either one carrier frequency or multiple carrier frequencies. Each device or a subset of devices will be associated with one or more anchor frequencies based on their subchannel assignment. For example, when the subchannel size is one carrier frequency, a device may be assigned subchannel 1 and accordingly it will be assigned the anchor frequency of the subchannel. Subsequently, this device will contiguously monitor the subchannel to detect the carrier frequency, harvest its energy, and then perform back scattering. This device may also monitor the other carriers within the subchannel to obtain the received control and data as shown in FIG. 14 for the TDD case.

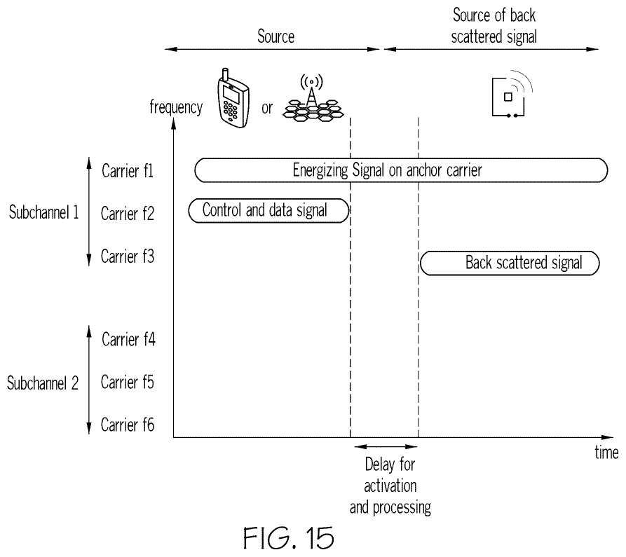

FIG. 14 illustrates a subchannel carrying an energizing signal along with control and data signals, according to various embodiments. Referring to FIG. 14, the control and data transmissions from the source are time multiplexed with the back scattered signal for simplicity and resource efficiency. However, in some cases, these transmissions may occur on different frequencies with the control/data signal and back scattered signal still in the same subchannel, as shown in FIG. 15.

FIG. 15 illustrates FDD support between the control/data signals from the source and the back scattered signal from the ambient IoT device, according to various embodiments. Referring to FIG. 15, the downlink control and data signals may use, for example, carrier f2, whereas the uplink back scattered signal may use a different carrier such as carrier f3. Using different carriers may help reduce the burden on the AIoT device when doing the up or down conversion of the energizing signal for back scattering. Since carrier f2 and carrier f3 are part of the same subchannel and close together in frequency, the AIoT device may easily shift frequencies and subsequently save energy. The delay for activation and processing may be used for energy harvesting. The frame structure of FIG. 15 supports the time and frequency multiplexing of energizing and control signaling from one or more reader devices such as a UE or gNB, which is convenient for environments having multiple devices in the same physical area.

The example embodiment of FIG. 15 may be for a type-A UE. One factor to consider for a type-A UE is that since this type of UE cannot process/transmit without an energizing signal, the downlink and uplink transmissions need to occur consecutively. This limitation puts constraints on the resource pool. In particular, the resource pool is common for downlink type (D-type) and uplink type (U-type) resources, U-type associated resources may need to follow associated D-type resources, and/or a guard time/processing delay between the D-type and U-type sections of the resource pool may be needed.

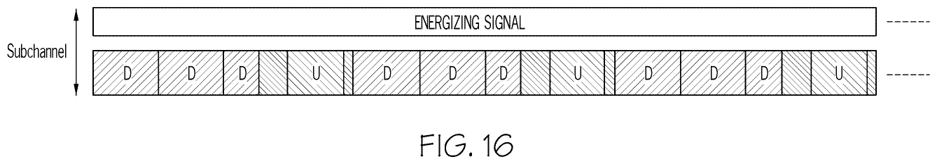

FIG. 16 illustrates the subchannel structure for a subchannel in the resource pool for type-A UEs in the TDD case, according to various embodiments. Referring to FIG. 16, the resource pool for the type-A device includes a number of time resources (slots) for type-D resources, a (D,U) time guard, a number of associated type U resources (slots) for type-U transmissions, and a (U, T) time guard to switch from type-U to type-D resources. The (D,U) time guard may be necessary for the device to switch from type-D to type-U resources, and for processing the data/control received during in the type-D resources. The type U resources (slots) for type-U transmissions may be linked to the type-D resources such that a device having listed on the type-D resources would transmit on that type-U resources. The (U, T) time guard to switch from type-U to type-D resources may be optional in some embodiments. For example, the AIoT may transmit until the end of the type-U slot, and then skip the next (D, U) cycle. In such a case, no time guard would be needed.

The resource pool configuration may indicate, in addition to the previous parameters described earlier, the D, U organization of the slot, the (D,U) time guard, and/or the (U,D) time guard. The (D,U) time guard may not need to be signalled, and may include a pre-determined (or signalled) number of symbols punctured at the end of the last D resource or at the beginning of the U resource. In some embodiments, the (D,U) time guard may be a number of unoccupied slots. The time guard is between the downlink slot and the uplink slot.

The energizing signal may start before the D-type resources so that AIoT devices can energize themselves. This energizing time may be referred to as E-time and may be signalled in the resource pool configuration. The energizing time may include the first symbols of the first D resource of the resource pool that are punctured. In some embodiments, the first slots of the resource pool may only include the energizing signal. The energizing signal may be transmitted in the slots immediately preceding the resource pool.

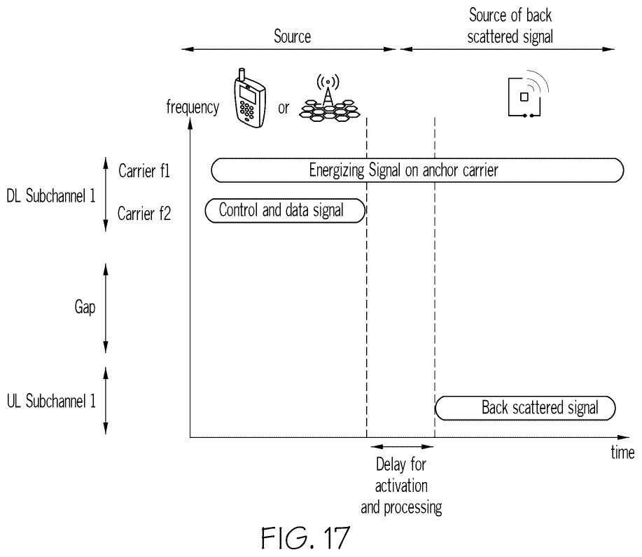

There may be an FDD implementation where the back scattered signal and control/data signal are transmitted at different paired frequencies. However, depending on the underlying bandwidth part (BWP) configuration and resource pool configuration, this might not be possible. The BWP is a section of bandwidth that is segmented (i.e., a resource pool). Subsequently, the control and data signals and the energizing signal from the source may occur on a separate BWP from that used for the back scattering as shown in FIG. 17.

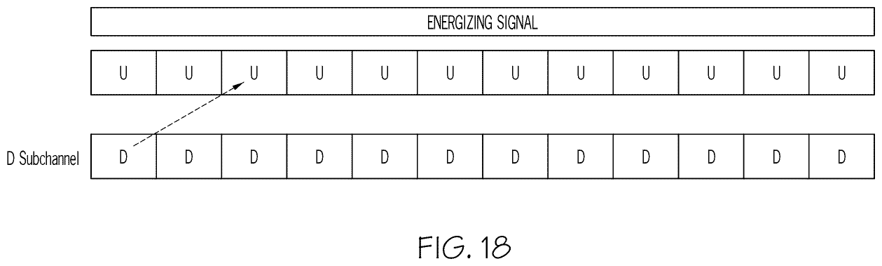

FIG. 17 illustrates FDD support between the control/data signals from the source and the back scattered signal from the ambient IoT device in separate bandwidth parts (BWPs), according to various embodiments. Referring to FIG. 17, the energizing signal is shown on the downlink subchannel. In some embodiments, the energizing signal may be located on the uplink subchannel as well, and/or transmitted in both the downlink and uplink subchannel, to simplify the AIoT architecture (as discussed in the previous section). The delay for activation and processing is still needed, and the DL resources must be associated with UL resources that are ideally adjacent. Thus, the resource pool structure may still need to have the U-D linkage. This U-D linkage is illustrated in FIG. 18.

FIG. 18 illustrates the subchannel structure for a subchannel in the resource pool for type-A UEs in the TDD case, according to various embodiments. The (D,U) and (U,D) time guards are not shown, but are present. Referring to FIG. 18, these time guards are fixed to one time slot. These time guards may be set to one or more symbols in some scenarios. Thus, the AIoT UE would be able to listen/transmit half of the time, assuming the same time resources allocated for D and U. However, if multiple AIoT devices are multiplexed together, it is possible to have all the resources utilized.

Since there exists an intermediate node that may be operating on a sidelink spectrum that is different from the gNB, the energizing signal and the control and data signals may occur in different BWPs or resource pool when their sources are different. Contiguous monitoring discussed herein refers to filtering of the received signal. In particular, the device on-board RF element will be matched to the frequency of the assigned subchannel and thus the power received from this subchannel will be detected. The device may be assigned from a previous round or by pre-configuration to monitor the assigned subchannel for detecting the energizing carrier. The assignment may be changed through control signaling from the source.

In some embodiments, an energizing signal may be transmitted in each subchannel in order to activate the AIoT devices and charge the on-board energy storage. In some embodiments, the energizing signal may be sent in a frequency different from that used for transmission of control and data signals by the source. In some embodiments, a source may apply time multiplexing between the control/data signals and the back scattered signal or they may be sent on separate carrier frequencies. In some embodiments, an association between the DL and the UL resources might be needed as well as processing delay to ensure that AIoT devices may receive an energizing signal before performing the back scattered transmission. The resource pool configuration may need to indicate the D,U organization of the slot, the (D,U) time guard (for processing and switching), and/or the (U,D) time guard, which may be optional for processing and switching. In some embodiments, the source of the energizing signal may be different from the source of the control and data signals.

Due to the simplicity of the AIoT devices and their power limitations, it is expected that the ambient IoT devices will have a relaxed latency constraint and thus a self-contained frame structure may not be needed. On the other hand, this may require the transmission of an energizing signal such that the device may be activated and perform a transmission. To address these aspects, a frame structure for ambient IoT devices may include an energizing signal, a control signal, a payload signal, and/or a feedback signal.

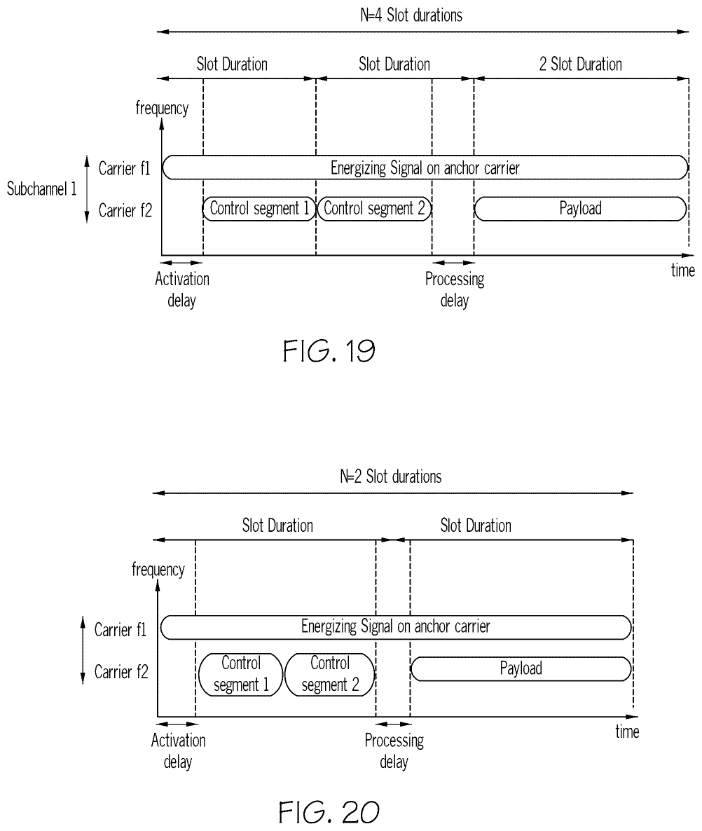

The energizing signal may provide the energy necessary for the device activation as well as providing the signal necessary for back scattering. The control signal may carry the control signaling (e.g., the scheduling information to the AIoT device, the targeted device type, the device ID, the type of requested information, the request for resource selection assistance, etc.) from the source or the intermediate node to the AIoT device. The payload signal may carry the payload signal from the source to the intermediate node. Examples of such payload include an AIoT device update or resource selection information. The feedback signal may be transmitted from the AIoT device to the source or the intermediate node and may include a feedback signal corresponding to the payload or the control signal received (e.g., ACK/NACK or resource selection assistance information, etc.), a control signal to carry the control information such as the ambient IoT device ID, information type, device type and capabilities, and/or a payload signal to carry the additional information based on the underlying application or the advertised service. The payload signal may also include some control information that is either encoded separately in the form of a second stage control signal or may include control information in the form a MAC control element. An example of a frame structure that is designed to support AIoT devices is illustrated in FIG. 19 where the downlink/sidelink portion that is transmitted from the source.

FIG. 19 illustrates a frame structure design to support ambient IoT devices, according to various embodiments. To simplify the design of AIoT systems, the reader to device control signaling may be divided into multiple segments and detected based on device capability. Splitting of the DL control signaling reduces the processing burden on low complexity AIoT devices. This allows the inclusion of additional control signaling for more capable AIoT devices for performance enhancement. For example, scheduling information may be sent in control segment 2 for more capable devices to avoid the limitations of random resource selections.

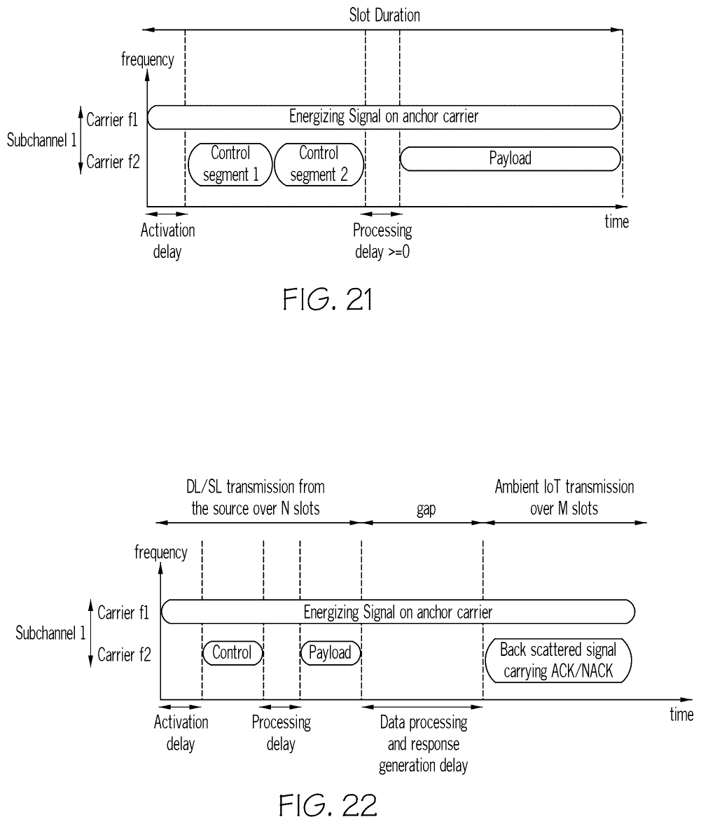

Referring to FIG. 19, an energizing signal may transmitted by the source or an intermediate node to activate the ambient IoT device and charge the on-board energy storage (e.g., for Type-B UEs). An activation delay may be included in the design to allow for enough time for device activation and charging of the device. The duration of this delay may be pre-configured per resource pool and may be dependent on the targeted device type. For example, device Type-B may have a much longer activation delay when compared to devices Type-A. In FIG. 19, each control segment is shown to occupy one slot, however in other cases, the two control segments may be included within one slot duration along with the activation duration, as shown in FIG. 20. In some cases, it might also be possible to include the activation duration, control, and payload into one slot, as shown in FIG. 21.

FIG. 20 illustrates an ambient IoT frame structure with all control signals contained within one slot, according to various embodiments. Referring to FIG. 20, control segment 1 and control segment 2 are included in one slot, whereas the payload is included in a different slot. A processing delay is between the two control segments and the payload.

FIG. 21 illustrates an ambient IoT frame structure with all control and data signals contained within one slot, according to various embodiments. Referring to FIG. 21, control segment 1, control segment 2, and the payload are included in one slot. A processing delay is between the two control segments and the payload, within the single slot.

In addition, the activation duration may be dependent on or more factors and may span more than one slot duration. The activation duration may be dependent on the device data priority, the device location, and/or the number of activated AIoT devices. Higher priority transmission may be allowed more activation delay to ensure that the device acquired enough energy for activation. Devices far from the energy source may require more energizing time. The larger the number of devices, the higher the chances that some devices will not be close to the source.

Once the activation delay is complete, a control signal may be transmitted from the source to the AIoT device. This control signal may be either a single segment or it may be divided into two or more segments to reduce the processing requirements at the AIoT device. The number of control segments may be pre-configured per resource pool and may be dependent on multiple factors including the targeted device type and the transmission priority. These segments may be either jointly encoded for simplicity or they may be independently encoded to improve the reliability of the transmission. In cases where two control segments are pre-configured as illustrated in FIG. 20, the first control segment may be used to activate one AIoT device by including its ID or a subset of the AIoT devices by including their groupcast ID. On the other hand, the second segment may include additional information that may be required by a subset of the devices. For example, the second segment may include the required power amplification by the AIoT device Type-B which is not required for AIoT devices of Type-A. The decoding requirement of the control segments may be dependent on the device type or by indication. For instance, Type-A may be pre-configured to decode only control segment 1 whereas Type-B devices may be pre-configured to decode control segments 1 and 2. On the other hand, the control segment 1 may include a flag (either implicitly or explicitly) to indicate the number of remaining control segments and whether an AIoT device is required to decode the signal or not.

Following the transmission of the control segments, a processing delay is included to allow enough time for the AIoT devices to process the received control information. The duration of this processing delay may be pre-configured per resource pool and may be dependent on the targeted UE Type. In some cases, this processing delay may be equal to zero if the AIoT device may buffer the received control and data segments before processing them. For instance, a Type-B UE might be required to process the second control segment and thus would require a longer processing delay whereas a Type-A UE may be required to process only the first control segment and thus might not require as long a processing time. The length of the processing time may also be indicated in the first control segment either implicitly or explicitly. Finally, when a source is able to schedule a future transmission of an AIoT device or a subset of devices, it may dynamically indicate the number of control segments, the processing delay and the activation delay to save power and reduce the latency. This indication may indicate an index from a pre-configured table per resource pool.

Once the processing delay duration is complete, the source may then send a payload to the targeted AIoT devices. This payload may also include some control information in the form of MAC control elements. Examples of control information may include resource selection assistance information, configuration parameters, and/or activation/deactivation of a set of AIoT devices. The duration of the payload transmission may be either pre-configured per resource pool to cover more than one slot duration or it may be dynamically indicated by the associated control segments. In some cases, to save power and reduce latency, the source may dynamically indicate the absence of the payload through the associated control information.

In some embodiments, the back scattered signal may be used to carry different types of information including ACK/NACK feedback or resource selection assistance information, control information, and/or payload from the device to the source. In some embodiments, the energizing signal may be triggered before the associated control/data signal from the source to allow enough time for energizing the AIoT device. This duration, referred to as the activation delay, may be pre-configured per resource pool or may be select based on multiple parameters. In some embodiments, the control information from the source may be divided into multiple segments to reduce the processing requirements at the AIoT devices. Some simple AIoT types (e.g., Type-A) may be required to decode only the first segment of the control signal. In some embodiments, the duration of the payload may be either dynamically indicated by the associated control signaling or it may be pre-configured to reduce the signaling overhead.

Once an AIoT device is able to receive the control and data information from the source, it is expected that it will continue to perform transmission. This transmission may simply include an ACK/NACK feedback or resource selection assistance information, as shown in FIG. 22.

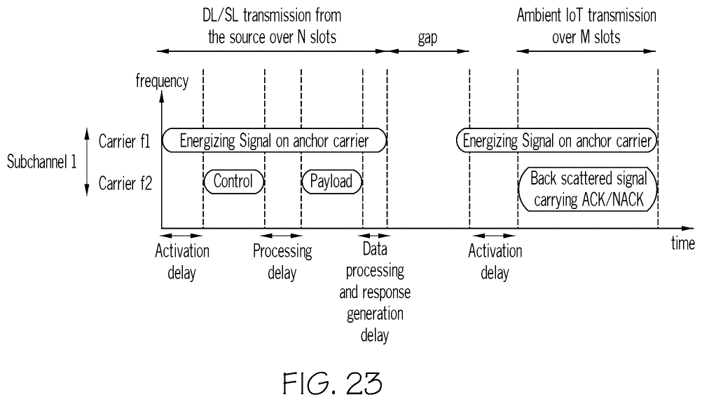

FIG. 22 illustrates an example frame structure design that carries the feedback information from the ambient IoT devices to the source, according to various embodiments. Referring to FIG. 22, the energizing signal is maintained to ensure that the AIoT device retains activity until it performs the feedback transmission. A processing delay may occur between transmitting the control signals and transmitting the payload. The same carrier may be used for the back scattering signal as the control and payload signals. the duration of the feedback transmission (the M slots in FIG. 23) may depend on multiple factors and may be either pre-configured per resource pool or dynamically indicated by the associated control information received from the source. The gap illustrated in FIG. 22 is expected to be larger than a pre-configured threshold per resource pool to allow enough time for processing of the received payload. This threshold may be dependent on the targeted device type (e.g., longer duration for device Type-A than the duration of device Type-B since these devices are expected to have lower processing capabilities). In some embodiments, to save power, the energizing signal can be stopped after the payload is received then reactivated again from the designated slot for transmitting the feedback as illustrated in FIG. 23.

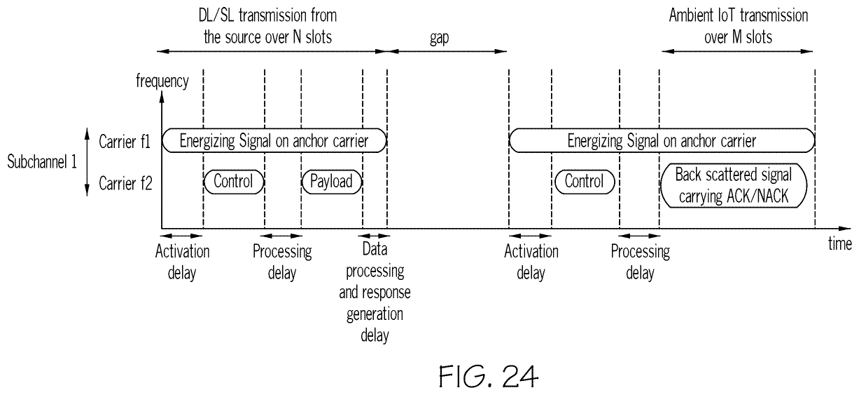

FIG. 23 illustrates a frame structure with a time gap in the energizing signal to save power, according to various embodiments. Referring to FIG. 23, the energizing signal extends beyond the payload duration to maintain the AIoT device active such that it may have enough time to process the received control and payload. In addition, an activation delay is introduced before the back scattering signal to allow enough time for activation and pre-processing. The duration of this activation delay before the backscattering may also be extended by pre-configuration to allow Type-B devices to charge its on-board energy storage and accordingly perform power amplification. Unlike in sidelink transmissions, the gap may not need to be larger than a pre-configured threshold since the processing of the received payload and the associated control channel will not continue in the absence of the energizing signal. Hence, the summation of the data processing duration and the activation delay durations are expected to be larger than the pre-configured threshold to allow enough time for energizing and data processing. In some embodiments, the above frame structure may result in a confusion since AIoT device that missed the first control portion might be activate and expect control information from the source. To address this drawback, one possibility is to include an additional control segment before the back scattering transmission without an associated payload as shown in FIG. 24.

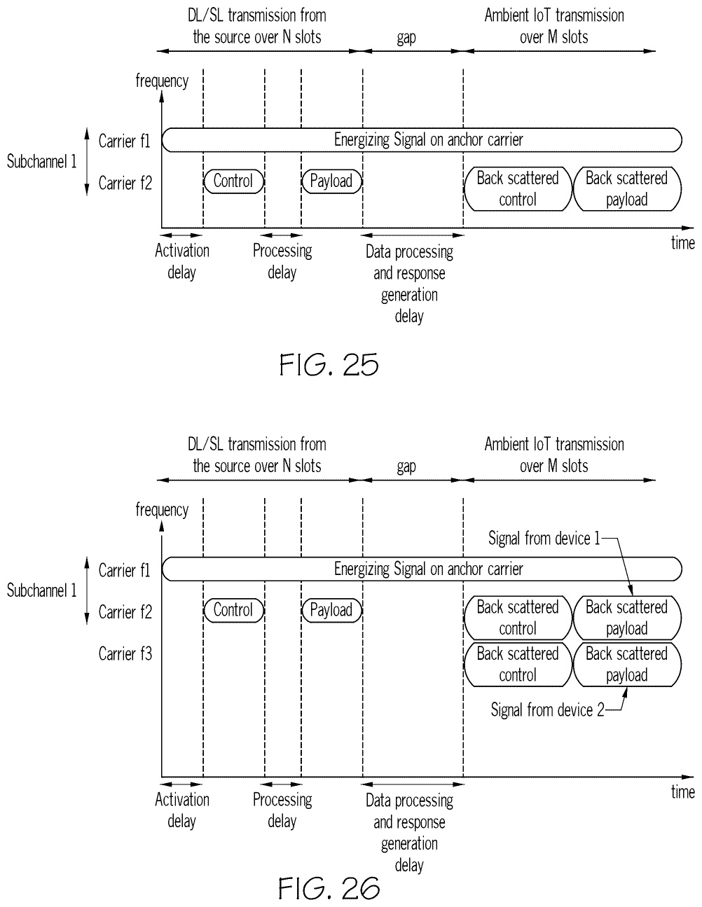

FIG. 24 illustrates an additional control signal that is added after the time gap duration to ensure the triggering of only the targeted devices, according to various embodiments. Referring to FIG. 24, after the time gap and subsequent activation delay, another control signal is added to ensure that targeted devices and addressed. In other scenarios, the back scattered signal is expected to carry control and data to either the source UE or to an intermediate node. In this case, the source should ensure that the duration of the energizing signal is sufficient for the UE to transmit the back scattered signal. This duration may be indicated to the AIoT device through the associated control signaling either before or after the gap. One example of this structure is in FIG. 25 when there is no gap between the source and the ambient IoT transmissions.

FIG. 25 illustrates that the energizing signal is extended to ensure enough time for the reception of the back scattered signal, according to various embodiments. Referring to FIG. 25, the control and payload sent by the AIoT device are expected to span M slots where M is larger than or equal to one slot duration. The control and data sent by the AIoT devices may be multiplexed in the frequency domain. In particular, each AIoT device may be assigned a specific carrier frequency over which it can perform its own back scattering and send its control and data to the source. An example of this approach is illustrated in FIG. 26.

FIG. 26 illustrates frequency multiplexing of the back scattered signal from multiple ambient IoT devices in one subchannel, according to various embodiments. Referring to FIG. 26, the signals from multiple AIoT devices are sent on different carriers within one subchannel.

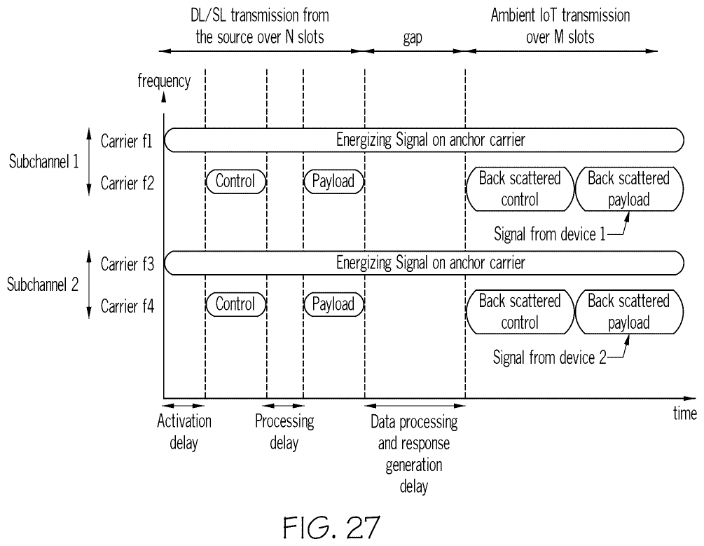

FIG. 27 illustrates frequency multiplexing of the back scattered signal from multiple ambient IoT devices in multiple subchannels, according to various embodiments. Referring to FIG. 27, the transmissions from different AIoT devices are sent on different carriers in different subchannels. In this case, the control and payload sent by the source must be repeated within each subchannel. The subchannels may be either adjacent to one another or there may exist a guard band between adjacent subchannels to reduce the impact of interference due to power leakage. In addition, the energizing signals may be located in the center frequency of a subchannel to reduce the impact of power leakage between the energizing signal and the back scattered signals.

In some embodiments, to preserve power, a gap may be introduced between the two segments of the energizing signal, i.e., the energizing signal used to activate the AIoT device and receive the control/signals from the source and the energizing signal used for back scattering. In some embodiments, to support devices Type-A, the energizing signal may be extended after the reception of the control/data signal to allow for enough energy for processing at the AIoT device. In some embodiments, to support devices Type-A, the energizing signal may be extended before the triggering point of the back scattered signal to enable the reactivation of the AIoT device. In some embodiments, when a gap exists before the energizing signal used for the back scattered signal, a second control signal may be transmitted by the source to schedule the transmission of the back scatter signal. In some embodiments, the back scattered control and data transmissions from an AIoT device may be time multiplexed within one carrier frequency. In some embodiments, the back scattered transmissions from neighboring AIoT devices may be frequency multiplexed either in the same subchannel or in different subchannels. In some embodiments, a frequency guard band may exist between adjacent subchannels to reduce the interference incurred due to energy leakage, especially between the energizing signal and the back scattered signals.

A frame structure design with a dedicated energizing signal for type-B UEs will now be discussed in detail. To a large extent, type-B AIoT devices may use a similar frame structure to that of Type-A AIoT devices. However, two major differences are that the type-B AIoT device needs more time to harvest energy before transmitting, and the transmission and the reception may occur at different times, and may not be linked since they have energy storage. In the general case, a different resource pool may be used for transmitting and receiving.

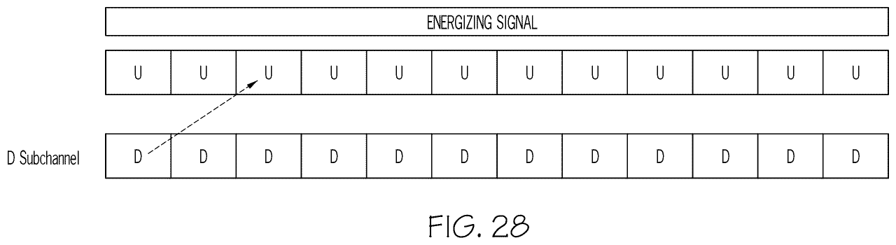

FIG. 28 illustrates an FDD resource pool structure with contiguous energizing signal, according to various embodiments. Referring to FIG. 28, an aspect to consider is the energy-harvesting of type-B AIoT devices. These devices have amplifiers, and must gather significantly more energy than type-A AIoT devices, most likely over several slots. In some embodiments, the energizing signal may continuously transmitted, so that type-B devices may energize outside of the resource pool as shown in FIG. 28.

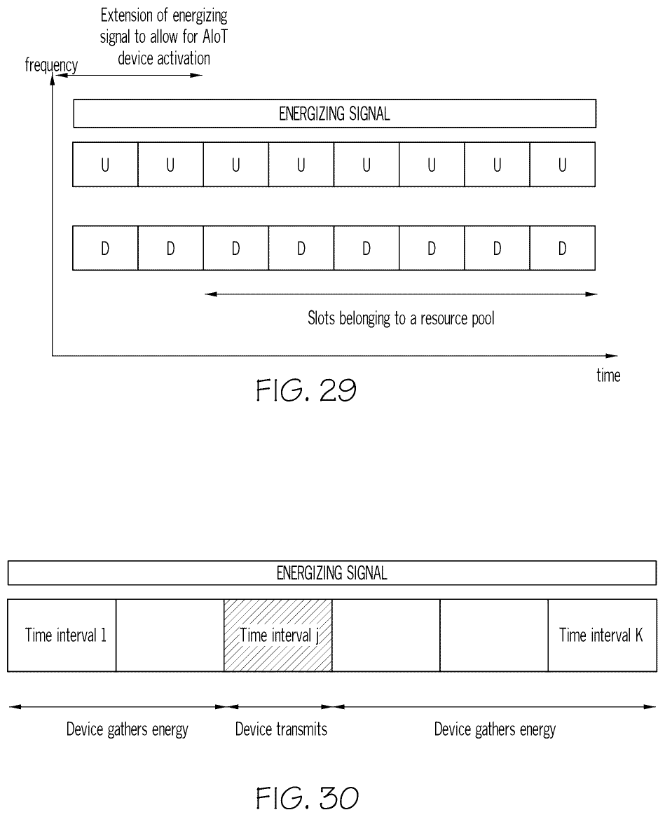

FIG. 29 illustrates an FDD resource pool structure with the energizing signal sent two slots before the first slot of a resource pool for device activation and energy harvesting, according to various embodiments. Referring to FIG. 29, the energizing signal may transmitted for a given duration before the resource pool begins, or the first slots of the resource pools may include only the energizing signal. This solution might be suitable for some scenarios. However, if the type-B device needs to gather significant energy, this may lead to high overhead. An example when the energizing signal is sent in the slot proceeding the resource pool is illustrated in FIG. 29.

FIG. 30 illustrates a resource pool structure (U-pool) for type-B UEs with slots dedicated for energy harvesting, according to various embodiments. Referring to FIG. 30, the UE may monitor or transmit in only a subset of the resource pool. In particular, the resource pool may be split into K time intervals. Each device may transmit or receive during one interval j. During the other K-1 intervals, the UE is not expected to transmit. However, the energizing signal may be present, and the UE is expected to harvest energy during that time interval as shown in FIG. 30.

In terms of configuration, the resource pool configuration may indicate time organization into K zones (in number of slots). The device may know which zone to monitor. This can be accomplished either by pre-configuration, or may be derived from, for example, a device ID. In some embodiments, the energizing signal may be either continuously present or it can be transmitted for a given duration before the resource pool begins to allow for energy harvesting by Type-B AIoT devices. In some embodiments, the resource pool can be divided into K zones wherein each AIoT device Type-B performs transmission/monitoring in only a subset (one or more) of the zones and perform energy harvesting in the remaining zones. In some embodiments, the number of monitored zones and/or the associated zone may be pre-configured to be derived by the AIoT device, such as, for example, based on device ID).

A frame structure design with a common energizing signal will now be discussed in detail. The transmission of multiple carrier wave (CW) signals may result in increased power consumption, increased occupied bandwidth, and increased interference between the back scattered signal and the CW. A solution to these problems is to use a common energizing signal with small frequency shifts. This may reduce the overhead and possible interference by relying on a common CW for energizing of AIoT devices. The use of small frequency shifts to multiplex the transmissions from neighboring AIoT devices may improve overall system performance. Small frequency shifts rely on time separation, i.e., small delays in time to achieve small frequency shifts on the order of 1 kHz to 100 kHz. Large frequency shifts may be on the order of tens of MHz. Small frequency shifts entail a relatively small time delay, but does not move to a different carrier.

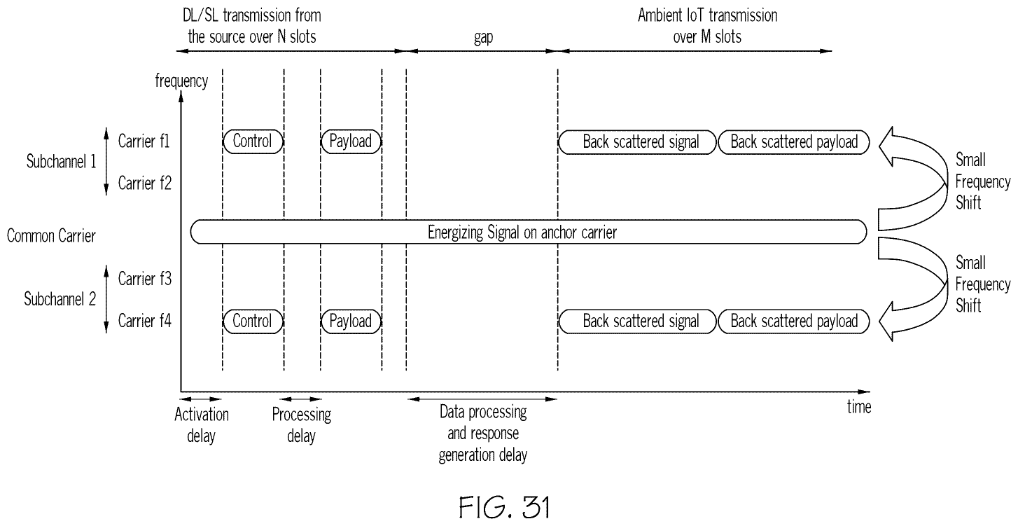

Ambient IoT devices may rely on the presence of an energizing signal in order to be able to perform the back scattering and transmit the required control/data to the source or intermediate node. Previously, a dedicated approach was considered in which for each ambient IoT device or a subset of ambient IoT devices a dedicated energizing signal is sent within the subchannel. An advantage of this approach is that carrier frequency may be easily monitored by the AIoT devices with limited processing capabilities and may also simplify the process of back scattering since the back scattered signal and the received energizing signal will have similar/comparable carrier frequencies. On the other hand, the retransmission of the energizing signal in each subchannel may result in a resource and power wastage. To address this drawback, a common energizing signal that can be monitored by all ambient IoT devices and used for back scattering is considered. In particular, for each resource pool, a carrier frequency may be pre-configured to carry the energizing signal for AIoT devices as shown in FIG. 31.

FIG. 31 illustrates the use of a common energizing signal to energize ambient IoT devices, according to various embodiments. Referring to FIG. 31, a common carrier may be pre-configured as a carrier over which the energizing signal is transmitted. Although the energizing signal is transmitted in FIG. 31 in the gap that is designated for data processing, in other scenarios the gap might not be occupied by an energizing signal to preserve power. In some embodiments, it may be easier for the AIoT devices to perform back scattering on a lower frequency than the original energizing signal (i.e., down conversion) and thus the energizing signal may be sent on the highest carrier frequency within the resource pool. In some embodiments, it might be easier for the AIoT devices to perform back scattering on a higher frequency than the original energizing signal (i.e., up conversion) and thus the energizing signal may be sent on the highest carrier frequency within the resource pool. In some embodiments, to avoid interference with neighboring cells, it may be desired to send the energizing signal in the middle of the assigned spectrum. The presence of the energizing signal will be dependent on the presence of a transmissions to/from an AIoT device. In other words, to preserve power and reduce interference, the source may refrain from transmitting the energizing signal on the common carrier when no communications with nearby AIoT devices is needed or expected.

The location of the common carrier over which the energizing is sent may also be indicated in the broadcast channel. In particular, an AIoT may be required to detect a broadcast channel before performing transmission. The location of this broadcast channel may be pre-configured per resource pool. Once this broadcast channel is detected, a UE may identify the location of the common carrier over which the energizing signal is transmitted.

To reduce the burden on the AIoT devices (i.e., less up/down conversion and less bandwidth to monitor), it may be also possible that one common energizing signal is transmitted every N subchannels where N is a pre-configured parameter per resource pool. For example, one energizing signal may be sent every other subchannel such that the AIoT devices relying on this energizing signal for back scattering will need to only perform a limited up/down conversion. The value of N may also be dependent on the neighboring AIoT device density. For instance, a larger number of energizing signals (i.e., a lower value of N) may be pre-configured when the AIoT device density is above a pre-configured threshold and another smaller number of energizing signal used otherwise. The values of N and the device density thresholds may be pre-configured per resource pool. The source may identify the device density in the discovery phase. In some embodiments, the value of N may also be dependent on the priority of the neighboring AIoT devices. In particular, the higher the priority of the supported devices, a lower value of N may be used to ensure that all devices may adequately perform energy harvesting. The value of N may also be used to combat channel fading. In particular, some AIoT devices might experience a deep fade on the common carrier transmitting the energizing signal. Hence, having multiple energizing signals (e.g., one energizing signal in every other subchannel), may provide transmission diversity and accordingly allow the AIoT to harvest the required energy for their operation.

In some embodiments, a common energizing signal may be used to activate all the AIoT devices in the system. In some embodiments, the carrier over which the common energizing signal is transmitted may be pre-configured per resource pool or indicated by the broadcast channel. In some embodiments, the carrier over which the common energizing signal is transmitted may be either sent in the highest or lowest or the center frequency within the resource pool. In some embodiments, to reduce the burden on the AIoT devices, one common energizing signal may be transmitted every N subchannels, where N is a pre-configured parameter per resource pool.

The objective of CW signal is to act as an energy source for energy harvesting and back scattering based transmissions by AIoT devices. However, this design may not be efficient as the occupied resources by CWs are not used. Additional DL control channel may be needed on a separate frequency resource, which increases the burden on an AIoT device to receive and process signals. This problem may be magnified in cases with multiple CWs are being transmitted by neighboring intermediate nodes. To address these issues, according to some embodiments, a modulated energizing signal may be used. Using a modulated CW to carry the DL control/data signaling in addition to providing the energy needed for energy harvesting provides efficient transmission of the DL control and/or data signals. Delays are introduced in which either repetitions of the DL signaling or no signaling is transmitted to allow for energy harvesting by low-end AIoT devices.

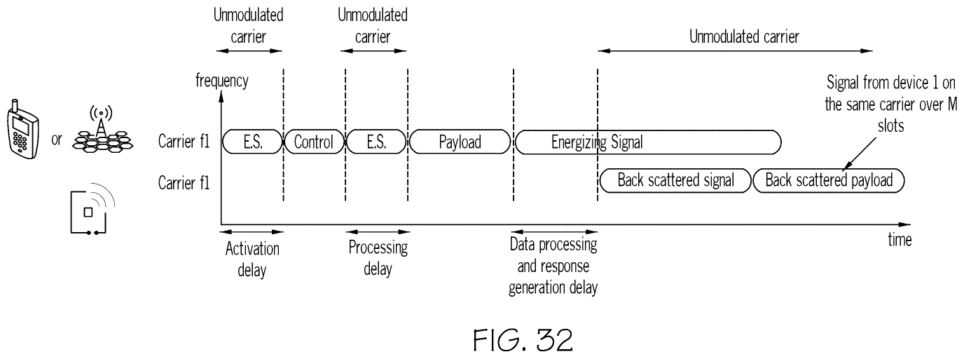

Type-A and Type-B AIoT devices are expected to receive an energizing signal in order to activate and perform their back scattering transmissions. Despite the importance of this energizing signal, it may also be used to carry information from the source to the AIoT devices. In particular, the source may apply amplitude shift keying (ASK) or phase shift keying (PSK) on the energizing signal before transmitting it to the targeted AIoT devices. Subsequently, the AIoT devices may detect this signal and use it as an energy source as well as a source of information. One example of this approach is illustrated in FIG. 32.

FIG. 32 illustrates the use of a modulated energizing signal to trigger ambient IoT devices, according to various embodiments. Referring to FIG. 32, a modulated energizing signal may be used to activate the AIoT devices. During the activation delay duration, the AIoT device performs energy harvesting during the activation delay to acquire enough energy for processing. The duration of this delay may depend on multiple aspects including the targeted device type. For instance, the duration may be extended for Type-B UEs to allow enough time for charging the onboard energy storage.

During the control/payload duration, the AIoT device may perform energy harvesting to maintain its activity as well as detect the modulated signal on the energizing signal by, for example, applying envelope detection in case of amplitude shift keying. In this duration, the energizing signal serves a dual purpose by allowing the AIoT device to maintain an active state while carrying the associated control and data to the targeted AIoT device. We note that during this phase, the energizing signal may oscillate between modulated and non-modulated durations to accommodate the processing delay at the AIoT device. For example, the energizing signal may be first modulated by the control signal (including the one or more segments as discussed in the previous sections) then be followed by a non-modulated duration to allow for control signal detection and processing. Subsequently, another modulated duration may be triggered to carry the payload from the source to the AIoT device. This is then followed by a non-modulated duration to allow for processing of the payload at the AIoT device.

During the back scattering duration, the AIoT device may perform energy detection to acquire the received energizing signal and then perform the backscattering on the same frequency to transmit control and data signals.

In some embodiments, to improve the resource utilization efficiency, the energizing signal may be modulated by the control and data signals from the source (e.g., by using ASK or PSK). In some embodiments, gap durations may exist within the energizing signal that contain no information to allow for energy harvesting at the AIoT devices.

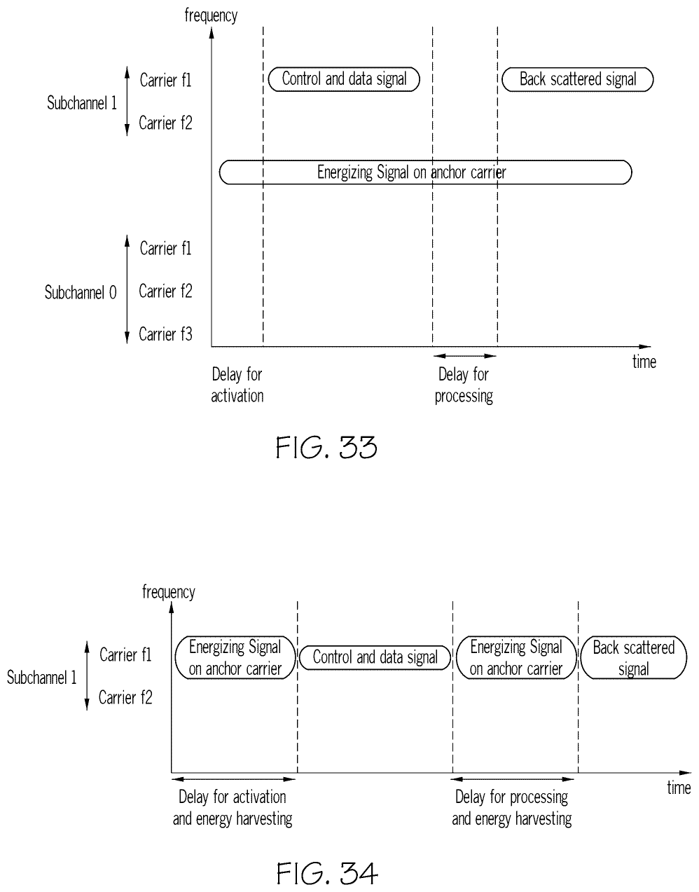

FIG. 33 illustrates a TDD frame structure for ambient IoT Type-A devices, according to various embodiments. Referring to FIG. 33, a time division duplexing (TDM)-based frame structure may support the transmissions to/from ambient IoT devices. TDM may offers advantages over FDM including: 1) the same antenna may be used for RF harvesting and data transmission and reception; and 2) for device Type-B, TDD has the advantage of being able to align harvesting and transmission by utilizing TDD configuration that determines the ratio of time to transmission and harvesting.

Still referring to FIG. 33, A common energizing signal is sent to activate all neighboring ambient IoT devices, whereas the data and control transmissions from the source are time multiplexed with the back scattered signal. The location of the energizing signal may be pre-configured per resource pool. In addition, since the source of the control and/or data signals may be different from the source of the energizing signal, they can be sent on a different BWP. For example, the energizing signal may be transmitted over the sidelink whereas the control and/or data signals are sent over the Uu link.

FIG. 34 illustrates a TDD frame structure for ambient IoT Type-B devices, according to various embodiments. Referring to FIG. 34, For the TDD frame structure design, two aspects are considered. Firstly, if TDM is applied between the energizing signals and any other signals, an AIoT device Type-A may lose its energy source and accordingly would not be able to process the received control/data. Hence, time multiplexing between energizing signals and other signals is applicable to Type-B devices which are capable of energy storage. Secondly, the duration of the time multiplexing for Type-B devices should not exceed their energy storage. Hence, if long data/control transmissions are expected, then it is expected that the ambient IoT device will oscillate between energy harvesting and detection.

Still referring to FIG. 34, the dedicated energizing signal is time multiplexed with the control/data signals from the source as well as the back scattered signal. Unlike the design illustrated in FIG. 33, the duration of the energizing signal and the activation delay are extended here to allow enough time for energy harvesting before the source switches to an actual control/data transmission. We note that the activation delay can be pre-configured per resource pool and can be dependent on the targeted device type. In addition, it can also be dependent on the number of targeted ambient IoT devices as well as their location with respect to the source of the energizing signal. A common energizing signal may be used to activate the AIoT devices. In this case, the energizing signal may be sent in a pre-configured location or a location indicated by the broadcast channel.

Unlike the FDD approach, a tighter synchronization may be required such that a UE is able to distinguish between the energizing signal and the control/data signal. To achieve this, a UE may need to perform synchronization before engaging in communication. This synchronization may be achieved by contiguous decoding or by using a modulated energizing signal. When using contiguous decoding, an AIoT device may be pre-configured to attempt to decode the control/data signal once it has a successful energization level. Subsequently, it may detect the control and data signals coming from the source. When using a modulated energizing signal the energizing signal may serve two purposes in the sense that it may be used for energy harvesting as well as for control and data transmissions. In this case, the AIoT device will rely on the received signal to activate its internal circuity and charge the on board energy source in case of a Type-B device, as well as for receiving the control and data signals from the source.

In some embodiments, the energy storage capacity of the ambient IoT device should be taken into consideration when performing time multiplexing of the control/data signal and energizing signals. In some embodiments, when using a modulated energizing signal with time multiplexing, the control and data portions may be separated by non-modulated durations to allow for energy harvesting.

The decoding of control and data signals may be triggered in a variety of ways. Since AIoT devices may be of different types, have different antenna configurations, and have varying separation from the energizing source, AIoT devices may need different durations for energizing. Hence, to ensure that all targeted devices have an adequate amount of time for energizing, the source may have an enlarged activation delay to allow the devices enough time for energy harvesting. In some embodiments, to save power and reduce latency, the selection of this energizing duration may be dependent on the feedback received from the ambient IoT devices or on channel measurements of the back scattering signal. For example, if the source measures the strength of a previous back scattering signal at a level above a threshold, it may use a shorter energizing duration (e.g., select a shorter pre-configured duration from a list). On the other hand, if the measured strength of the previous signal is below a threshold, a longer energizing duration may be selected. In some embodiments, an ambient IoT device may indicate the required energizing duration in its back scattering signal based on internal measurements. In particular, the AIoT device may perform measurements (e.g., based on the received signal strength of the energizing signal or the time needed to charge the on-board energy storage) and accordingly provide an indication to the source to select the energizing signal duration for future transmission. Subsequently, once this message is received, the source may accurately select the duration of the energizing signal. If multiple requests or measurements are received from multiple ambient IoT devices, the source may select the longest energizing duration to reach the device with the worst channel conditions.

In most cases, the energizing signal will be followed by the control/data signals from the source. In some embodiments, the control and data signals may be received after receiving the energizing signal from a different source. In both cases, the AIoT device needs to be able to identify the beginning of the control/data to be able to correctly receive the coded information. To address this problem, approaches using a gap during or using continuous monitoring may be considered. In the gap duration approach, a gap duration may be introduced between the energizing signal and the control/data signal. In this case, a UE first receives the energizing signal to activate and charge the on-board energy source. Subsequently, once the gap is detected, the UE switches to the decoding mode and then attempts to receive the control and data signals. However, the gap should not be too long in order to be applicable to AIoT device Type-A. If the gap duration is too long, the device may lose its energy and will need to be reactivated. In the continuous monitoring approach, an AIoT device may autonomously switch to the receiving mode once energy harvesting and charging of the on-board energy source are completed.

In some embodiments, the activation delay may be designed based on the worst case scenario by considering the longest required duration from the targeted ambient IoT devices. In some embodiments, the detection of the required activation duration may be done either through direct channel measurements by the source on previous transmissions or through measurement and feedback from the targeted ambient IoT devices. In some embodiments, to detect the starting of the control and data signals after energy harvesting, an ambient IoT device may rely on the presence of a gap duration from the source before these signals. In some embodiments, to detect the starting of the control and data signals after energy harvesting, an ambient IoT device may rely on continuous monitoring by autonomously switching to the decoding mode once the energy harvesting is completed.

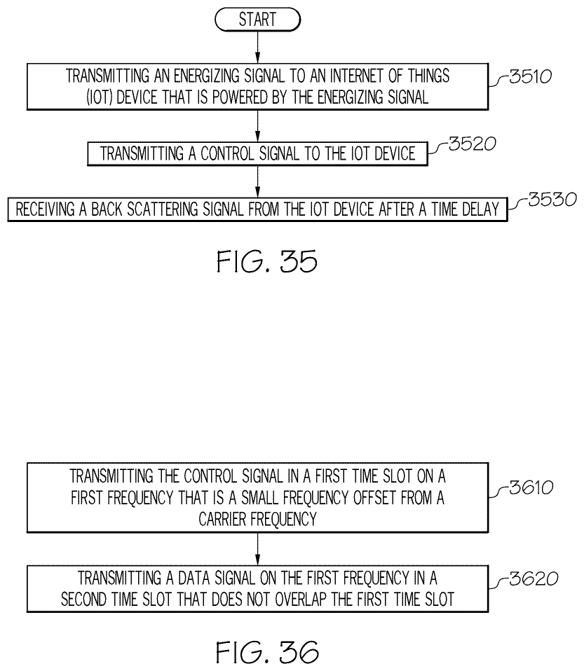

FIGS. 35 to 40 are flowcharts of operations according to various embodiments described herein. Referring to FIG. 35, the method includes transmitting an energizing signal to an Internet of Things (IoT) device that is powered by the energizing signal, at block 3510. The method includes transmitting a control signal to the IoT device, at block 3520. The method includes receiving a back scattering signal from the IoT device after a time delay, at block 3530. The time delay is between the transmitting of the control signal and the receiving of the back scattering signal. The time delay may include time for energy harvesting of the energy signal by the IoT device. The time delay may include an activation time of the IoT device or processing time of the control signal by the IoT device. The control signal may include a first control segment and a second control segment. The first control segment may be transmitted after an activation delay for the IoT device to be activated, and the second control segment may be transmitted after the first control segment. the first control segment may include low complexity communication and the second control segment may include high complexity communication. The energizing signal may include a common energizing signal used by a plurality of IoT devices including the IoT device, and each of the plurality of IoT devices may use the common energizing signal with a respective small frequency shift from a carrier frequency of the common energizing signal. When performing back scattering, each of the plurality of ambient IoT devices has a respective small frequency shift from a carrier frequency of the common carrier wave resulting in Frequency Division Multiple Access (FDMA) of ambient IoT device transmissions of the plurality of ambient IoT devices

Referring to FIG. 36, the energizing signal may include a common energizing signal used by a plurality of IoT devices including the IoT device. The method further includes transmitting the control signal in a first time slot on a first frequency that is a small frequency offset from a carrier frequency, at block 3610. The method includes transmitting a data signal on the first frequency in a second time slot that does not overlap the first time slot, at block 3620. The first time slot and the second time slot are separated by the time delay.

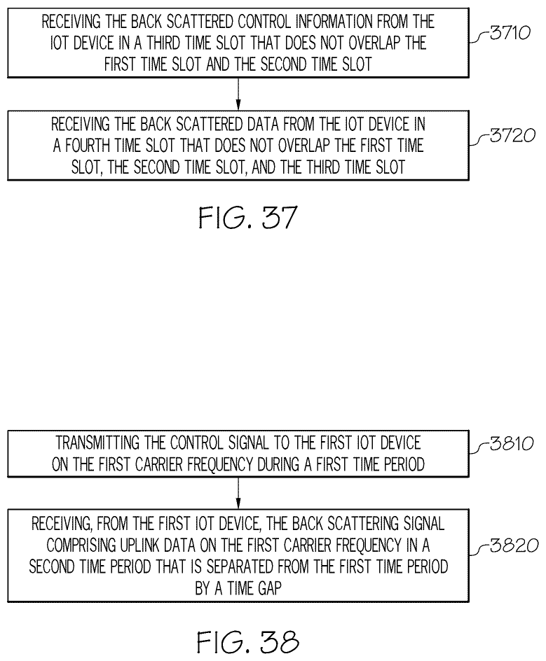

Referring to FIG. 37, the back scattering signal may include back scattered control information and back scattered data. The method may further include receiving the back scattered control information from the IoT device in a third time slot that does not overlap the first time slot and the second time slot, at block 3710. The method may include receiving the back scattered data from the IoT device in a fourth time slot that does not overlap the first time slot, the second time slot, and the third time slot, at block 3720.

The energizing signal may include a respective dedicated energizing signal for each of a plurality of IoT devices. A first IoT device of the plurality of IoT devices may use a first carrier wave at a first carrier frequency and a second IoT device of the plurality of IoT devices uses a second carrier wave at a second carrier frequency that is different from the first carrier frequency. Referring to FIG. 38, the method may further include transmitting the control signal to the first IoT device on the first carrier frequency during a first time period, at block 3810. The method may include receiving, from the first IoT device, the back scattering signal including uplink data on the first carrier frequency in a second time period that is separated from the first time period by a time gap, at block 3820.

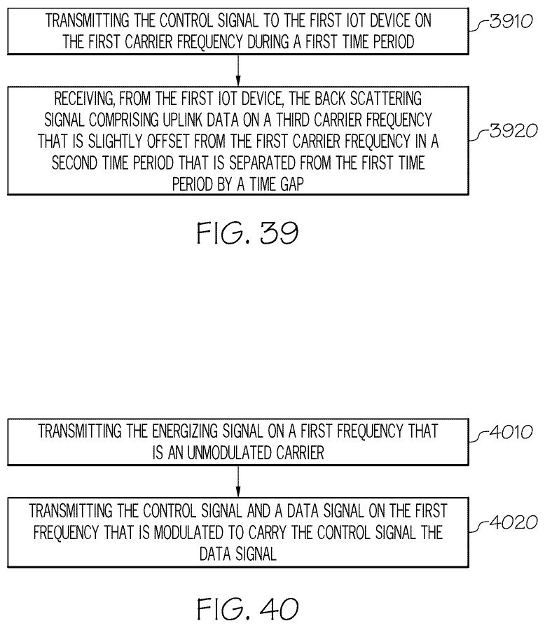

Referring to FIG. 39, the method may further include transmitting the control signal to the first IoT device on the first carrier frequency during a first time period, at block 3910. The method may include receiving, from the first IoT device, the back scattering signal including uplink data on a third carrier frequency that is slightly offset from the first carrier frequency in a second time period that is separated from the first time period by a time gap, at block 3920. The energizing signal may include a modulated energizing signal including a modulated carrier wave that carries control information and/or data information.

Referring to FIG. 40, transmitting the control signal to the IoT device may include transmitting the energizing signal on a first frequency that is an unmodulated carrier, at block 4010. The method may include transmitting the control signal and a data signal on the first frequency that is modulated to carry the control signal the data signal, at block 4020. The method may further include receiving the back scattering signal from the IoT device on a second frequency that is different from the first frequency.

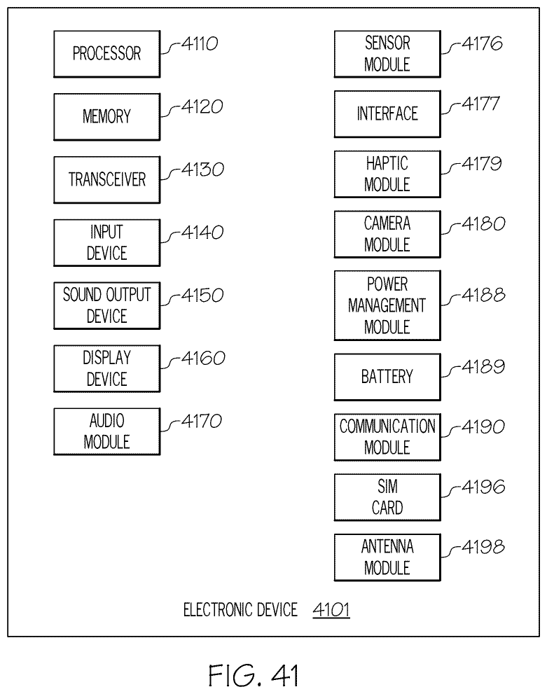

FIG. 41 is a block diagram of an electronic device in a network environment, according to some embodiments. This device may be similar to the reader 140 of FIG. 1, base station 110 of FIG. 4, intermediate node 120 of FIG. 5, assisting node 115 of FIG. 6 or FIG. 7, UE 125 of FIG. 8, and may perform operations similar to those of the flowcharts of FIGS. 35 to 40. Referring to FIG. 41, an electronic device 4101 in a network environment as in FIG. 1, may communicate with a gNB or base station 110 via a first network (e.g., a wireless communication network or radio channel). The electronic device 4101 may include a processor 4110, a memory 4120, an input device 4150, a sound output device 4155, a display device 4160, an audio module 4170, a sensor module 4176, an interface 4177, a haptic module 4179, a camera module 4180, a power management module 4188, a battery 4189, a communication module 4190, a subscriber identification module (SIM) card 4196, or an antenna module 4197. In some embodiments, at least one (e.g., the display device 4160 or the camera module 4180) of the components may be omitted from the electronic device 4101, or one or more other components may be added to the electronic device 4101. Some of the components may be implemented as a single integrated circuit (IC). For example, the sensor module 4176 (e.g., a fingerprint sensor, an iris sensor, or an illuminance sensor) may be embedded in the display device 4160 (e.g., a display).

The processor 4110 may execute software (e.g., a program) to control at least one other component (e.g., a hardware or a software component) of the electronic device 4101 coupled with the processor 4110 and may perform various data processing or computations, such as the operations of the flowcharts of FIGS. 35 to 40.

In some embodiments, at least one memory device 4120 may include computer program code embodied on a non-transitory computer readable medium. The computer program code may be configured to cause the at least one processor 4110 to perform operations including transmitting an energizing signal to an IoT device that is powered by the energizing signal, transmitting a control signal to the IoT device, and receiving a back scattering signal from the IoT device after a time delay. The transceiver 4130 of the electronic device 4101 may use the antenna module 4197 to transmit control and/or data channel data to the IoT device.

As at least part of the data processing or computations, the processor 4110 may load a command or data received from another component (e.g., the sensor module 4176 or the communication module 4190) in memory 4120, process the command or the data stored in the memory 4120, and store resulting data in memory 4120. The processor 4110 may include a main processor (e.g., a central processing unit (CPU) or an application processor (AP)), and/or an auxiliary processor (e.g., a graphics processing unit (GPU), an image signal processor (ISP), a sensor hub processor, or a communication processor (CP)) that is operable independently from, or in conjunction with, the main processor. Additionally or alternatively, the auxiliary processor may be adapted to consume less power than the main processor, or execute a particular function. The auxiliary processor may be implemented as being separate from, or a part of, the main processor.

The auxiliary processor may control at least some of the functions or states related to at least one component (e.g., the display device 4160, the sensor module 4176, or the communication module 4190) among the components of the electronic device 4101, instead of the main processor while the main processor is in an inactive (e.g., sleep) state, or together with the main processor while the main processor is in an active state (e.g., executing an application). The auxiliary processor (e.g., an image signal processor or a communication processor) may be implemented as part of another component (e.g., the camera module 4180 or the communication module 4190) functionally related to the auxiliary processor.

The memory 4120 may store various data used by at least one component (e.g., the processor 4110 or the sensor module 4176) of the electronic device 4101. The various data may include, for example, software (e.g., the program) and input data or output data for a command related thereto. The memory 4120 may include the volatile memory or the non-volatile memory. Non-volatile memory may include internal memory and/or external memory. The program may be stored in the memory 4120 as software, and may include, for example, an operating system (OS), middleware, or an application.

The input device 4150 may receive a command or data to be used by another component (e.g., the processor 4110) of the electronic device 4101, from the outside (e.g., a user) of the electronic device 4101. The input device 4150 may include, for example, a microphone, a mouse, or a keyboard.

The sound output device 4155 may output sound signals to the outside of the electronic device 4101. The sound output device 4155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 4160 may visually provide information to the outside (e.g., a user) of the electronic device 4101. The display device 4160 may include, for example, a display, a hologram device, or a projector and control circuitry to control a corresponding one of the display, hologram device, and projector. The display device 4160 may include touch circuitry adapted to detect a touch, or sensor circuitry (e.g., a pressure sensor) adapted to measure the intensity of force incurred by the touch.

The audio module 4170 may convert a sound into an electrical signal and vice versa. The audio module 4170 may obtain the sound via the input device 4150 or output the sound via the sound output device 4155 or a headphone of an external electronic device directly (e.g., wired) or wirelessly coupled with the electronic device 4101.

The sensor module 4176 may detect an operational state (e.g., power or temperature) of the electronic device 4101 or an environmental state (e.g., a state of a user) external to the electronic device 4101, and then generate an electrical signal or data value corresponding to the detected state. The sensor module 4176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 4177 may support one or more specified protocols to be used for the electronic device 4101 to be coupled with the external electronic device directly (e.g., wired) or wirelessly. The interface 4177 may include, for example, a high-definition multimedia interface (HDMI), a universal serial bus (USB) interface, a secure digital (SD) card interface, or an audio interface.

The haptic module 4179 may convert an electrical signal into a mechanical stimulus (e.g., a vibration or a movement) or an electrical stimulus which may be recognized by a user via tactile sensation or kinesthetic sensation. The haptic module 4179 may include, for example, a motor, a piezoelectric element, or an electrical stimulator.

The camera module 4180 may capture a still image or moving images. The camera module 4180 may include one or more lenses, image sensors, image signal processors, or flashes. The power management module 4188 may manage power supplied to the electronic device 4101. The power management module 4188 may be implemented as at least part of, for example, a power management integrated circuit (PMIC).

The battery 4189 may supply power to at least one component of the electronic device 4101. The battery 4189 may include, for example, a primary cell which is not rechargeable, a secondary cell which is rechargeable, or a fuel cell.

The communication module 4190 may support establishing a direct (e.g., wired) communication channel or a wireless communication channel between the electronic device 4101 and the external electronic device (and performing communication via the established communication channel. The communication module 4190 may include one or more communication processors that are operable independently from the processor 4110 (e.g., the AP) and supports a direct (e.g., wired) communication or a wireless communication. The communication module 4190 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via the first network (e.g., a short-range communication network, such as BLUETOOTH™, wireless-fidelity (Wi-Fi) direct, or a standard of the Infrared Data Association (IrDA)) or the second network (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module may identify and authenticate the electronic device 4101 in a communication network, such as the first network or the second network, using subscriber information (e.g., international mobile subscriber identity (IMSI)) stored in the subscriber identification module 4196.

The antenna module 4197 may transmit or receive a signal or power to or from the outside (e.g., the external electronic device) of the electronic device 4101. The antenna module 4197 may include one or more antennas, and, therefrom, at least one antenna appropriate for a communication scheme used in the communication network, such as the first network or the second network, may be selected, for example, by the communication module 4190 (e.g., the wireless communication module). The signal or the power may then be transmitted or received between the communication module 4190 and the external electronic device via the selected at least one antenna. The antenna module 4197 may be coupled to the transceiver 4130 to facilitate transmitting and receiving signals by the electronic device 4101.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific example teachings discussed above, but is instead defined by the following claims.

What is claimed is:

1. A system comprising:
a node comprising a transceiver configured to transmit and receive signals to an ambient Internet of Things (A-IoT) device;
wherein the node is configured to perform operations comprising:
transmitting a carrier wave to the A-IoT device;
transmitting a control signal and/or a payload signal to the A-IoT device; and
receiving a back scattering signal from the A-IoT device after a time delay,
wherein the time delay lasts at least a duration between the transmitting of the control signal and/or the payload signal and the receiving of the back scattering signal.

2. The system of claim 1,
wherein the time delay comprises time for energy harvesting of the carrier wave by the A-IoT device.

3. The system of claim 1,
wherein the time delay comprises an activation time of the A-IoT device or processing time of the control signal and/or the payload signal by the A-IoT device.

4. The system of claim 1, wherein the control signal comprises a first control segment and a second control segment,
wherein the first control segment is transmitted after an activation delay for the A-IoT device to be activated, and
wherein the second control segment is transmitted after the first control segment.

5. The system of claim 4, wherein low complexity devices are configured to decode the first control segment and high complexity devices are configured to decode the first control segment and the second control segment.

6. The system of claim 1, wherein the carrier wave comprises a common carrier wave used by a plurality of A-IoT devices that includes the A-IoT device, and
wherein, when performing back scattering, each of the plurality of A-IoT devices applies a respective small frequency shift from a carrier frequency of the common carrier wave resulting in Frequency Division Multiple Access (FDMA) of A-IoT device transmissions of the plurality of A-IoT devices.

7. The system of claim 1, wherein the carrier wave comprises a first carrier wave transmitted by a first reader device, and a second carrier wave transmitted by a second reader device,
wherein the first carrier wave and the second carrier wave are transmitted in a Time Division Multiple Access (TDMA) manner such that the first carrier wave is transmitted by the first reader device in a first time slot and the second carrier wave is transmitted by the second reader device in a second time slot, or
the first carrier wave and the second carrier wave are transmitted in a Frequency Division Multiple Access (FDMA) manner such that the first carrier wave is transmitted by the first reader device on a first frequency and the second carrier wave is transmitted by the second reader device on a second frequency.

8. The system of claim 1, wherein the carrier wave comprises a common carrier wave used by a plurality of A-IoT devices comprising the A-IoT device, and wherein the node is further configured to perform operations comprising:
transmitting the control signal in a first time slot on a first frequency that is a small frequency offset from a carrier frequency; and
transmitting a data signal on the first frequency in a second time slot that does not overlap the first time slot,
wherein the first time slot and the second time slot are separated by the time delay that is used by the A-IoT device for energy harvesting and/or processing.

9. The system of claim 8, wherein the back scattering signal comprises back scattered control information and back scattered data, and wherein the node is further configured to perform operations comprising:
receiving the back scattered control information from the A-IoT device in a third time slot that does not overlap with the first time slot and the second time slot; and
receiving the back scattered data from the A-IoT device in a fourth time slot that does not overlap with the first time slot, the second time slot, and the third time slot.

10. The system of claim 1, wherein the carrier wave comprises a respective dedicated carrier wave for each of a plurality of A-IoT devices, and
wherein a first A-IoT device of the plurality of A-IoT devices uses a first carrier wave at a first carrier frequency and a second A-IoT device of the plurality of A-IoT devices uses a second carrier wave at a second carrier frequency that is different from the first carrier frequency.

11. The system of claim 10, further comprising:
transmitting the control signal to the first A-IoT device on the first carrier frequency during a first time period; and
receiving, from the first A-IoT device, the back scattering signal comprising device to reader data on the first carrier frequency in a second time period that is separated from the first time period by a time gap.

12. The system of claim 10, further comprising:
transmitting the control signal to the first A-IoT device on the first carrier frequency during a first time period; and
receiving, from the first A-IoT device, the back scattering signal comprising device to reader data on a third carrier frequency that is slightly offset from the first carrier frequency in a second time period that is separated from the first time period by a time gap.

13. The system of claim 1, wherein the carrier wave comprises a modulated carrier wave that is used to carry control information and/or data information.

14. The system claim 13, wherein transmitting the control signal to the A-IoT device comprises:
transmitting the carrier wave on a first frequency that is unmodulated in a first time slot; and
transmitting the control signal and a data signal on the first frequency in a second time slot, wherein the carrier wave is modulated to carry the control signal the data signal, wherein the first time slot is time separated from the second time slot.

15. The system of claim 14, further comprising:
receiving the back scattering signal from the A-IoT device on a second frequency that is shifted by a small frequency shift from the first frequency.

16. The system of claim 1, further comprising:
using frequency division duplexing (FDD) in which the control signal and/or the payload signal to the A-IoT device are transmitted in a carrier wave that is frequency separated from the back scattering signal from the A-IoT device, and the A-IoT device applies a large frequency shift when transmitting the back scattering signal, and
using time division duplexing (TDD) in which the control signal and/or the payload signal to the A-IoT device are transmitted in a first time slot that is separated from a second time slot in which the back scattering signal from the A-IoT device is received.

17. An electronic device comprising:
at least one processor;
a transceiver; and
at least one memory device comprising computer program code embodied on a non-transitory computer readable medium, wherein the computer program code is configured to cause the at least one processor to perform operations comprising:
transmitting a carrier wave to an ambient Internet of Things (A-IoT) device;
transmitting a control signal and a payload signal to the A-IoT device; and
receiving a back scattering signal from the A-IoT device after a time delay,
wherein the time delay lasts at least a duration between the transmitting of the control signal and/or the payload signal and the receiving of the back scattering signal.

18. The electronic device of claim 17,
wherein the time delay comprises time for energy harvesting of the carrier wave by the A-IoT device, an activation time of the A-IoT device, and/or a processing time of the control signal by the A-IoT device.

19. The electronic device of claim 17, wherein the control signal comprises a first control segment and a second control segment,
wherein the first control segment is transmitted after an activation delay for the A-IoT device to be activated,
wherein the second control segment is transmitted after the first control segment, and
wherein low complexity devices are configured to decode the first control segment and high complexity devices are configured to decode the first control segment and the second control segment.

20. A method comprising:
transmitting, by the transceiver, a carrier wave to an ambient Internet of Things (A-IoT) device;
transmitting, by the transceiver, a control signal and/or a payload signal to the A-IoT device; and
receiving, by the transceiver, a back scattering signal from the A-IoT device after a time delay,
wherein the time delay lasts at least a duration between the transmitting of the control signal and/or the payload signal and the receiving of the back scattering signal.
